(19) United States
(12) Patent Application Publication
(10) Pub. No.: US 2025/0287232 A1
(43) Pub. Date: Sep. 11, 2025

(54) ENHANCEMENT FOR EVENT MONITORING EXPOSURE

(71) Applicant: Telefonaktiebolaget LM Ericsson (publ), Stockholm (SE)

(72) Inventors: Qiang Liu, Shanghai (CN); Tianmei Liang, Shanghai (CN)

(21) Appl. No.: 18/291,743

(22) PCT Filed: Jul. 7, 2022
(86) PCT No.: PCT/CN2022/104424

§ 371 Date: Jan. 24, 2024

(30) Foreign Application Priority Data
Aug. 10, 2021 (WO) PCT/CN2021/111843

(51) Int. Cl. H04W 24/08; H04L 61/4588; H04W 92/24

(52) U.S. Cl. CPC H04W 24/08; H04L 61/4588; H04W 92/24

(57) ABSTRACT

The embodiments herein relate to enhancement for event monitoring exposure. In some embodiments, there proposes a method performed by a first network function implementing application function. In an embodiment, the method may comprise the step of transmitting a subscription message comprising at least one of Data Network Name of a data network and Single Network Slice Selection Assistance Information to a second network function implementing network exposure function, so as to monitor an event status for a User Equipment (UE) or a group of UEs. In an embodiment, the method may further comprise the step of receiving a notification message comprising information indicating the event status from the second network function. The embodiments herein allow the application function to subscribe PDN_CONNECTIVITY_STATUS event or other monitoring events (such DOWNLINK_DATA_DELIVERY_STATUS event) for a specific data network or 5G virtual network via Nnef_EventExposure_Subscribe service operation, for one or more UEs.

### TECHNICAL FIELD

The embodiments herein relate generally to the field of mobile communication, and more particularly, the embodiments herein relate to enhancement for event monitoring exposure.

### BACKGROUND

FIG. 1 is a schematic block diagram 100 showing example architecture for 5G network architecture at non-roaming scenario as defined by 3GPP. The relevant architectural aspects for event monitoring exposure include the Application Function (AF) 101, the Network Exposure Function (NEF) 102, the Unified Data Management (UDM) 104, and the Session Management function (SMF) 103.

The AF 101 interacts with the 3GPP Core Network, and specifically allows external parties to use the exposure Application Programming Interfaces (APIs) offered by the network operator. The NEF 102 supports different functionality and specifically supports event exposure API. The UDM 104 supports different functionality and specifically supports (group) identifier translation, and event exposure API. The SMF 103 supports different functionality and specifically supports event exposure API.

FIG. 2 is a schematic signaling chart showing the messages in the Packet Data Network (PDN) connectivity status subscription procedure, according to the prior art. As shown in FIG. 2, the following messages or steps are included:

1. The AF 101 invokes Nnef_EventExposure_Subscribe service operation (refer to 3GPP TS 23.502, v17.1.0) by sending an HTTP POST message as specified in MonitoringEvent API (refer to 3GPP TS 29.122, v17.2.0) to monitor the PDN_CONNECTIVITY_STATUS event for a group of UE (identified by External Group Id), or for a single UE (identified by External Id or Mobile Subscriber Integrated Services Digital Network Number (MSISDN)).

2. The NEF 102 maps Service Capability Server (SCS)/Application Server (AS) Identifier and External Group Id, External Id or MSISDN to a Data Network Name (DNN) based on local policy. In particular, if the event subscription is for a single UE, the NEF 102 derives the Generic Public Subscription Identifier (GPSI) based on the received External Id or MSISDN.

3. The NEF 102 queries the Network Repository Function (NRF) 105 to perform the network function discovery/selection for the UDM(s) 104 that serves the specific External Group Id or GPSI.

4. The NEF 102 invokes a Nudm_EventExposure_Subscribe service operation (refer to 3GPP TS 23.502, v17.1.0 and 3GPP TS 29.503, v17.3.0) to subscribe the PDN_CONNECTIVITY_STATUS event for the group of UE (identified by the External Group Id) or for a single UE (identified by GPSI), for the specific DNN derived in step 2. The UDM 104 creates corresponding event subscription and stores the event subscription data in the Unified Data Repository (UDR) (if the UDM 104 is a stateless UDM).

5. During Packet Data Unit (PDU) session establishment procedure, the SMF 103 registers with the UDM 104 using Nudm_UECM_Registration for the given PDU Session.

6. If the UDM 104 has existing applicable event exposure subscriptions for events detected in the SMF 103 for this UE or any of the groups this UE belongs to, (possibly retrieved from the UDR), the UDM 104 invokes the Nsmf_EventExposure_Subscribe service for creating the event exposure subscriptions.

7. For the SMF 103 registering to the UDM 104 in steps 5 and 6, the UDM 104 invokes a Nsmf_EventExposure_Subscribe service operation (refer to 3GPP TS 23.502, v17.1.0 and 3GPP TS 29.508, v17.3.0) to subscribe the PDU_SES_REL event and PDU_SES_EST event for the group of UE (identified by the External Group Id) if such event subscription is not created on that SMF 103 before.

8. The SMF 103 reports corresponding events to the NEF 102 directly via a Nsmf_EventExposure_Notify service operation (refer to 3GPP TS 23.502, v17.1.0 and 3GPP TS 29.508, v17.3.0).

9. The NEF 102 reports PDN_CONNECTIVITY_STATUS events to the AF 101 via a Nnef_EventExposure_Notify service operation (refer to 3GPP TS 23.502, v17.1.0) by sending an HTTP POST message as specified in MonitoringEvent API (refer to 3GPP TS 29.122, v17.2.0).

### SUMMARY

The embodiments herein propose methods, network functions, computer readable mediums and computer program products for PDN connectivity status subscription.

In some embodiments, there proposes a method performed by a first network function implementing application function (such as AF). In an embodiment, the method may comprise the step of transmitting a first subscription message comprising at least one of DNN of a data network and Single Network Slice Selection Assistance Information (S-NSSAI) to a second network function implementing network exposure function (such as NEF), so as to monitor an event status for a UE or a group of UEs. In an embodiment, the method may further comprise the step of receiving a first notification message comprising information indicating the event status from the second network function.

In an embodiment, the event status may be a PDN connectivity status or a downlink data delivery status.

In an embodiment, the first subscription message may further comprise at least one of an external group ID indicating the group of UE, an external UE ID indicating a specific UE, a MSISDN indicating a specific UE, a GPSI indicating a specific UE, and an indication indicating any UE.

In some embodiments, there proposes a method performed by a second network function implementing network exposure function (such as NEF). In an embodiment, the method may comprise the step of receiving a first subscription message comprising at least one of DNN of a data network and S-NSSAI from a first network function implementing application function (such as AF), so as to monitor an event status for a UE or a group of UEs. In an embodiment, the method may further comprise the step of determining a third network function implementing session management function (such as SMF) or a fourth network function implementing unified data management function (such as UDM) for the PDN connectivity status subscription. In an embodiment, the method may further comprise the step of transmitting a second subscription message comprising at least one of the DNN and S-NSSAI to the determined network function.

In an embodiment, the event status may be a PDN connectivity status or a downlink data delivery status.

In an embodiment, the first subscription message may further comprise at least one of an external group ID indicating the group of UE, an external UE ID indicating a specific UE, a MSISDN indicating a specific UE, a GPSI indicating a specific UE, and an indication indicating any UE.

In an embodiment, determining the network function may further comprise the step of querying a fifth network function implementing network repository function (such as NRF) for a fourth network function implementing unified data management (such as UDM) based on at least one of the external group ID, the external UE ID, the MSISDN, and the GPSI.

In an embodiment, the method may further comprise the step of performing, based on a local policy, an authorization for at least one of: the external group Id, the DNN, the external UE ID, the MSISDN, the GPSI, and the S-NSSAI.

In an embodiment, determining the network function may further comprise the step of querying a fifth network function implementing network repository function (such as NRF) for one or more third network functions implementing session management functions (such as SMF) based on the DNN and the S-NSSAI.

In an embodiment, the method may further comprise the step of translating the external group ID to an internal group ID based on a local policy. In another embodiment, the method may further comprise the step of translating the MSISDN or the external UE ID to GPSI based on a local policy.

In an embodiment, the method may further comprise the step of querying the fifth network function implementing network repository function (such as NRF) for a fourth network function implementing unified data management (such as UDM) based on the external group ID. In an embodiment, the method may further comprise the step of transmitting a request comprising external group ID to the fourth network function implementing unified data management. In an embodiment, the method may further comprise the step of receiving the internal group ID from the fourth network function implementing unified data management.

In an embodiment, the method may further comprise the step of receiving a second notification message comprising information indicating the event status from the third network function implementing session management function. In an embodiment, the method may further comprise the step of transmitting a first notification message comprising information indicating the event status to the first network function.

In some embodiment, there proposes a first network function implementing application function (such as AF). The first network function may comprise at least one processor and a non-transitory computer readable medium coupled to the at least one processor. The non-transitory computer readable medium may contain instructions executable by the at least one processor, whereby the at least one processor is configured to perform the above method steps related to the first network function.

In some embodiment, there proposes a second network function implementing network exposure function (such as NEF). The second network function may comprise at least one processor and a non-transitory computer readable medium coupled to the at least one processor. The non-transitory computer readable medium may contain instructions executable by the at least one processor, whereby the at least one processor is configured to perform the above method steps related to the second network function.

In some embodiments, there proposes a computer readable medium comprising computer readable code, which when run on an apparatus, causes the apparatus to perform any of the above methods.

In some embodiments, there proposes a computer program product comprising computer readable code, which when run on an apparatus, causes the apparatus to perform any of the above methods.

The embodiments herein allow the AF to subscribe PDN_CONNECTIVITY_STATUS event or other monitoring events (such as DOWNLINK_DATA_DELIVERY_STATUS) for a specific data network or 5G virtual network via Nnef_EventExposure_Subscribe service operation, for a single UE, a group of UE or any UE when the AF supports multiple and flexible DNNs and S-NSSAIs combinations.

The embodiments herein further allow the NEF to directly subscribe events on concerned SMFs for DNN and/or S-NSSAI based event(s) monitoring, to reduce unnecessary signaling messages between the UDM, the UDR, and the SMF, therefore the end to end latency and resource consumption/workload of the UDM and the UDR can be optimized.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 is a schematic block diagram showing example architecture for 5G network architecture at non-roaming scenario;

FIG. 2 is a schematic signaling chart showing the messages in the PDN connectivity status subscription procedure, according to the prior art;

FIG. 3 is a schematic signaling chart showing the messages in the PDN connectivity status subscription procedure, according to the embodiments herein;

FIG. 4 is another schematic signaling chart showing the messages in the PDN connectivity status subscription procedure, according to the embodiments herein;

FIG. 5 is yet another schematic signaling chart showing the messages in the PDN connectivity status subscription procedure, according to the embodiments herein;

FIG. 6 is a schematic flow chart showing an example method in the first network function, according to the embodiments herein;

FIG. 7 is a schematic flow chart showing an example method in the second network function, according to the embodiments herein;

FIG. 8 is a schematic block diagram showing an example first network function, according to the embodiments herein;

FIG. 9 is a schematic block diagram showing an example second network function, according to the embodiments herein;

FIG. 10 is a schematic block diagram showing an example computer-implemented apparatus, according to the embodiments herein.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in an embodiment” appearing in various places throughout the specification are not necessarily all referring to the same embodiment.

The term “A, B, or C” used herein means “A” or “B” or “C”; the term “A, B, and C” used herein means “A” and “B” and “C”; the term “A, B, and/or C” used herein means “A”, “B”, “C”, “A and B”, “A and C”, “B and C” or “A, B, and C”.

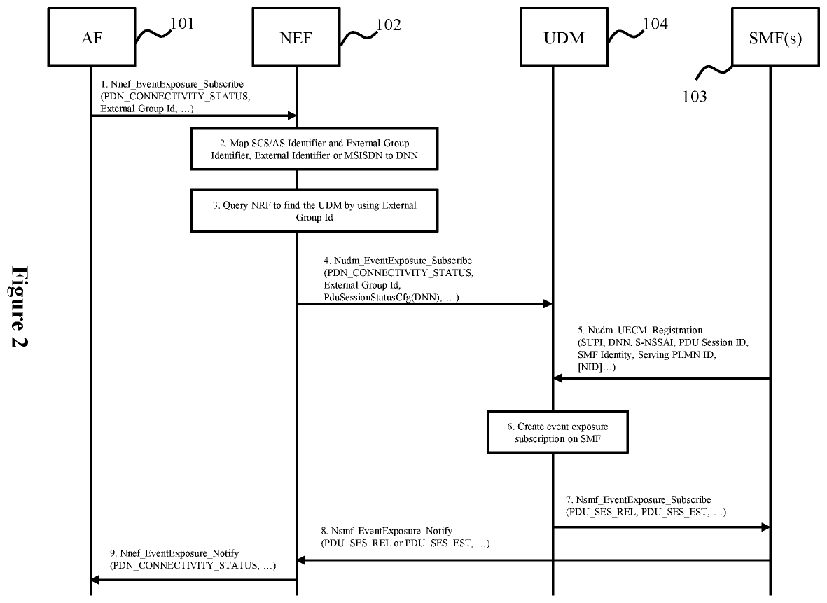

As mentioned above in FIG. 2, the PDN connectivity status subscription procedure according to the prior art may allow the AF 101 to subscribe the PDN connectivity status of UE. However, there are deficiencies with subscription procedure according to the prior art.

Problem 1: there is no definition in 3GPP technical specifications on how to map the UE identifiers to the DNN in the NEF 102. The NEF 102 locally mapping SCS/AS Identifier (Id) and External Group Identifier, External Identifier or MSISDN to DNN is not flexible/realistic in production.

There are following possible mapping options:
1. SCS/AS Id to DNN;
2. SCS/AS Id+External Group Id to DNN;
3. SCS/AS Id+External Id (or MSISDN) to DNN.

For option 1, for a new DNN, a new SCS/AS Id needs to be assigned. A new mapping between the SCS/AS Id and the DNN needs to be handshake between an AF operator and a telecommunication operator in advance, to reconfigure or adapt the AF 101 (new mapping from new SCA/AS Id to new DNN) and the NEF 102 (the NEF 102 may use SCS/AS Id for Authentication and Authorization).

The one to one mapping between the DNN and the SCS/AS Id (i.e., using a dedicated SCA/AS Id for a dedicated DNN) is an extra requirement to the AF 101 and introduces extra implementation complexity.

There are too many combinations for the aforementioned option 2 and option 3. For both the AF operator and the telecommunication operator, it is difficult to manage and maintain so many combinations.

Problem 2: the PDN connectivity status subscription procedure according to the prior art introduces unnecessary dependency on the UDM 104 and UDR (in case of stateless UDM) in terms of event subscription on the SMF 103.

For each PDU session registration from the SMF 103 to the UDM 104 using Nudm_UECM_Registration, the UDM 104 needs to fetch individual event exposure subscriptions related to this UE and/or individual event exposure group subscriptions related to this UE from the UDR and check which event subscriptions need to be created on the SMF 103. This behavior introduces lots of signaling interaction between the UDM 104 and the UDR for retrieving UDM event subscription data. As consequence, it introduces unnecessary latency and resource consumption (e.g., CPU, memory, storage, network bandwidth) in the UDM 104 and the UDR (since in case of stateless UDM, the UDM 104 needs to store subscription information in the UDR).

Besides, any further extension for PDN_CONNECTIVITY_STATUS event subscription will impact the UDM 104 (to support new extension attributes and logic) and the UDR (event subscription data model to be updated); which makes the PDN connectivity status subscription procedure according to the prior art difficult to extend for new exposure use cases.

In view of deficiencies with the PDN connectivity status subscription procedure according to the prior art, the embodiments propose a DNN attribute and/or a S-NSSAI attribute in data type MonitoringEventSubscription in MonitoringEvent API, to allow the AF 101 to the DNN specify and/or the S-NSSAI for PDN_CONNECTIVITY_STATUS event subscription, which may also be applicable to other monitoring types (such as DOWNLINK_DATA_DELIVERY_STATUS).

Furthermore, when receives the Nnef_EventExposure_Subscribe service operation from the AF 101 for PDN_CONNECTIVITY_STATUS event subscription, the embodiments herein propose a novel procedure in the NEF 102, where the NEF 102 may perform a SMF discovery/selection and it is possible for the NEF 102 to directly invoke the Nsmf_EventExposure_Subscribe service operation with the selected SMF(s) 103.

Furthermore, the embodiments herein also propose a new procedure in the NEF 102, where the NEF 102 may perform an authorization for external group Id, DNN and/or S-NSSAI based on the local policy.

In particular, the NEF 102 may also translate the External Group Id (if received) to an Internal Group Id based on the local policy instead of querying the UDM 104, therefore the NEF 102 may avoid or at least reduce the interaction with the UDM 104. That is, the NEF 102 may derive the GPSI from the External Id or the MSISDN (if received from the AF 101), and use the GPSI directly in the Nsmf_EventExposure_Subscribe service operation to subscribe the PDU_SES_REL event and PDU_SES_EST event, therefore direct interaction with the UDM 104 may be omitted or at least reduced.

In this disclosure, the application scenarios of the embodiments herein may occur in 5G system, in which the network functions may be implemented as the AF 101, the NEF 102, the UDM 104, the SMF 103, and so on.

It should be understood that, the application scenarios of the embodiments herein may also occur in other current telecommunication systems, e.g., 4G system or EPS or future telecommunication systems, where the network functions may have the same or similar functionalities as the above network functions in 5G system. For example, the SMF 103 in 5G system may be performed by the MME, Serving Gate Way (SGW), and PDN Gateway (PGW) which are responsible for session management function; the UDM 104 may be performed by a Home Subscriber Server (HSS) and the UDR may be performed by a Subscription Profile Repository (SPR); and the NEF 102 may be performed by a Service Capability Exposure Function (SCEF).

For simplicity purpose, the embodiments herein are based on 5G architecture. The embodiments herein may be applicable to 4G (EPC) architecture as well.

It should also be understood that, a network function may be implemented either as a network element on a dedicated hardware, as a software instance running on a dedicated hardware, or as a virtualized function instantiated on an appropriate platform, e.g. on a cloud infrastructure.

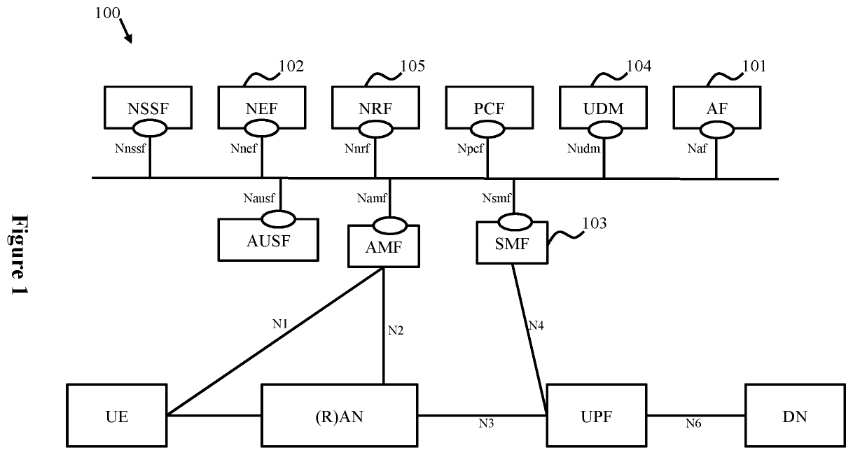

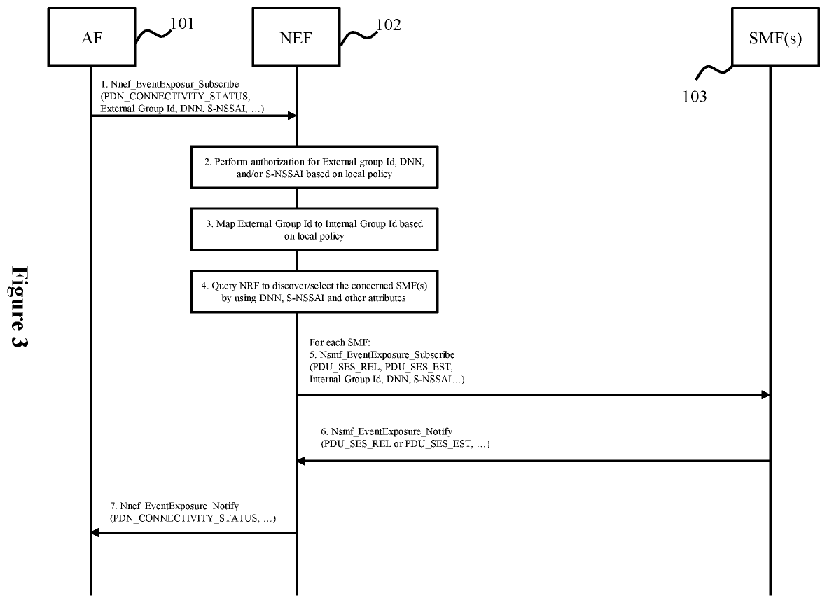

FIG. 3 is a schematic signaling chart showing the messages in the PDN connectivity status subscription procedure, according to the embodiments herein. The signaling in the schematic signaling chart may be implemented in the example 5G network architecture as shown in FIG. 1. Note that, the PDN connectivity status subscription is used here for example, the similar procedure may be also applicable for other event monitoring, such as downlink data delivery status.

In this schematic signaling chart, the NEF 102 may bypass the UDM 104 and directly subscribe event(s) on the SMF(s) 103. In an embodiment, the PDN connectivity status subscription procedure may include the following messages or steps:

1. The AF 101 may invoke the Nnef_EventExposure_Subscribe service operation by sending an HTTP POST message as specified in the MonitoringEvent API to monitor the PDN_CONNECTIVITY_STATUS event for a group of UE (identified by External Group Id) or for a single UE (identified by External Id, MSISDN, or GPSI) or for any UE, for a specific DN (identified by DNN) and/or S-NSSAI (optional). In FIG. 3, the External Group Id is used here as an example in the scenario of a group of UEs.

If the event subscription is for a single UE, the NEF 102 may derive the GPSI based on the received External Id or MSISDN.

If the subscription applies to events related to a single PDU session for a UE, the PDU Session ID of that PDU session as “pduSeId” attribute and the UE identification as “supi” or “gpsi” attribute may be used.

If the subscription applies to the event(s) not related to a single PDU session, the identification of UE(s) to which the subscription applies via the following may be used:
a) the identification of a single UE by a SUPI as “supi” attribute or a GPSI as “gpsi” attribute;
b) identification of a group of UE(s) via a “groupId” attribute;
c) identification of any UE via the “anyUeInd” attribute set to true;
d) the identification of a group of UE(s) within an DNN and/or S-NSSAI via a “groupId” attribute and any of “dnn” and “snssai” attributes; or
e) the identification of any UE within an DNN and/or S-NSSAI via the “anyUeInd” attribute set to true and any of “dnn” and “snssai” attributes.

In an embodiment, an example of the MonitoringEvent API is shown in the following table 1.

TABLE 1
MonitoringEvent API re-used Data Types

| Data type | Reference | Comments |
|---|---|---|
| CivicAddress | 3GPP TS 29.572 [42] | Civic address. |
| CodeWord | 3GPP TS 29.515 [65] | Code word. |
| DIDataDeliveryStatus | 3GPP TS 29.571 [45] | Traffic Descriptor of source of downlink data notifications. |
| DddTrafficDescriptor | 3GPP TS 29.571 [45] | Traffic Descriptor of source of downlink data. |
| Dnn | 3GPP TS 29.571 [45] | Identifies a DNN. |
| GeographicArea | 3GPP TS 29.572 [42] | Identifies the geographical information of the user(s). |
| CivicAddress | 3GPP TS 29.572 [42] | Identifies the civic address information of the user(s). |
| LocationQoS | 3GPP TS 29.572 [42] | Requested location QoS. |
| LdrType | 3GPP TS 29.572 [42] | Location deferred requested event type. |
| Velocity Requested | 3GPP TS 29.572 [42] | Velocity of the target UE requested. |
| AgeOfLocationEstimate | 3GPP TS 29.572 [42] | Age of the location estimate for change of location type or |
| | | motion type of Location deferred report. |
| AccuracyFulfilmentIndicator | 3GPP TS 29.572 [42] | The indication whether the obtained location estimate satisfies |
| | | the requested QoS or not. |
| VelocityEstimate | 3GPP TS 29.572 [42] | UE velocity, if requested and available. |
| LinearDistance | 3GPP TS 29.572 [42] | This IE shall be present and set to true if a location estimate is |
| | | required for motion event report. |
| NetworkAreaInfo | 3GPP TS 29.554 [50] | Identifies a network area information. |
| PositioningMethod | 3GPP TS 29.572 [42] | Identifies the positioning method used to obtain the location |
| | | estimate of the UE. |
| SACEventStatus | 3GPP TS 29.571 [45] | Contains the network slice status information related to network |
| | | slice admission control. |
| SACInfo | 3GPP TS 29.571 [45] | Represents network slice admission control information to |
| | | control the triggering of notifications or convey network slice |
| | | status information. |
| Snssai | 3GPP TS 29.571 [45] | Contains a S-NSSAI. |
| SupportedFeatures | 3GPP TS 29.571 [45] | Used to negotiate the applicability of the optional features |
| | | defined in table 5.3.4-1. |
| ServiceIdentiy | 3GPP TS 29.515 [65] | Service identity. |
| SupportedGADShapes | 3GPP TS 29.572 [42] | Supported Geographical Area Description shapes. |
| TimeWindow | 5.2.1.2.3 | Identifies the time interval. |

As may be seen from table 1, in an embodiment, the data type “Dnn” may be added into the MonitoringEvent API for identifying a DNN.

In an embodiment, another example of the MonitoringEvent API is shown in the following table 2.

TABLE 2
Reused APIs applicable for both EPS and 5GS

| API Name | Differences |
|---|---|
| ResourceManagementOfBdt | The “LocBdt_5G” feature as described in subclause 5.4.4 of 3GPP TS 29.122 [4] |
| | may only be supported in 5G. |
| | The “Group_Id” feature as described in subclause 5.4.4 of 3GPP TS 29.122 [4] |
| | may be supported in 5G. |
| | The “BdtNotification_5G” feature as described in subclause 5.4.4 of |
| | 3GPP TS 29.122 [4] may only be supported in 5G. |
| PfdManagement | The “FailureLocation_5G” feature as described in subclause 5.11.4 of |
| | 3GPP TS 29.122 [4] may only be supported in 5G. |
| MonitoringEvent | The “Number_of_UEs_in_an_area_notification_5G” feature as described in |
| | subclause 5.3.4 of 3GPP TS 29.122 [4] may only be supported in 5G. |
| | The “Downlink_data_delivery_status_5G” feature as described in subclause 5.3.4 |
| | of 3GPP TS 29.122 [4] may only be supported in 5G. |
| | The “Availability_after_DDN_failure_notification_enhancement” feature as |
| | described in subclause 5.3.4 of 3GPP TS 29.122 [4] may only be supported in 5G. |
| | For the “Pdn_connectivity_status” feature, APN is equivalent to DNN; msisdn(s) is |
| | equivalent to gpsi(s); the non-IP PDN type is equivalent to the unstructured PDU |
| | session type; and the enumeration InterfaceIndication value “PDN_GATEWAY” |
| | stands for PDU session anchored in UPF in 5G. |
| | The “eLCS” feature as described in subclause 5.3.4 of 3GPP TS 29.122 [4] may |
| | only be supported in 5G. |
| | The “NSAC” feature described in subclause 5.3.4 of 3GPP TS 29.122 [4] may only |
| | be supported in 5G. |
| DeviceTriggering | |
| CpProvisioning | The “ExpectedUMT_5G” and “ExpectedUmtTime_5G” features as described in |
| | subclause 5.10.4 of 3GPP TS 29.122 [4] may only be supported in 5G. |
| | The “ScheduledCommType_5G” feature as described in subclause 5.10.4 of |
| | 3GPP TS 29.122 [4] may only be supported in 5G. |
| ChargeableParty | The “EthChgParty_5G” and “MacAddressRange_5G” features as described in |
| | subclause 5.5.4 of 3GPP TS 29.122 [4] may only be supported in 5G. |
| | The events (i.e. LOSS_OF_BEARER, RECOVERY_OF_BEARER and |
| | RELEASE_OF_BEARER) do not apply for 5G. |
| AsSessionWithQoS | The “EthAsSessionQoS_5G”, “QoSMonitoring_5G”, “MacAddressRange_5G” and |
| | “AlternativeQoS_5G” features as described in subclause 5.14.4 of |
| | 3GPP TS 29.122 [4] may only be supported in 5G. |
| | The events (i.e. LOSS_OF_BEARER, RECOVERY_OF_BEARER and |
| | RELEASE_OF_BEARER) do not apply for 5G. |
| MsisdnLessMoSms | |
| NpConfiguration | The “NpExpiry_5G” feature as described in subclause 5.13.4 of 3GPP |
| | TS 29.122 [4] may only be supported in 5G. |
| NIDD | |
| RacsParameterProvisioning | |
| ECRControl | The “ECR_WB_5G” feature as described in subclause 5.12.4 of 3GPP TS |
| | 29.122 [4] may only be supported in 5G. |

As may be seen from table 2, in an embodiment, the expression “msisdn(s) is equivalent to gpsi(s)” may be added to the reused APIs applicable for both EPS and 5GS, for emphasizing that the MSISDN(s) is equivalent to GPSI(s) in identifying the UE(s).

In an embodiment, an example of the data type MonitoringEventSubscription in MonitoringEvent API is shown in the following table 3.

TABLE 3
Definition of type MonitoringEventSubscription

| Attribute name | Data type | Cardinality | Description | Applicability |
|---|---|---|---|---|
| externalId | ExternalId | 0 . . . 1 | Identifies a user as defined in Clause | |
| | | | 4.6.2 of 3GPP TS 23.682 [2]. | |
| Msisdn | Msisdn | 0 . . . 1 | Identifies the MS internal PSTN/ISDN | |
| | | | number allocated for a UE. | |
| externalGroupId | ExternalGroupId | 0 . . . 1 | Identifies a user group as defined in | |
| | | | Clause 4.6.2 of 3GPP TS 23.682 [2]. | |
| addExtGroupIds | array(ExternalGroupId) | 0 . . . N | Identifies user groups as defined in | Number_of_UEs_ |
| | | | Clause 4.6.2 of 3GPP TS 23.682 [2]. | in_an_area_ |
| | | | | notification, |
| | | | | Number_of_UEs_ |
| | | | | in_an_area_ |
| | | | | notification_5G |
| Dnn | Dnn | 0 . . . 1 | Identifies a DNN, a full DNN with both the | Session_ |
| | | | Network Identifier and Operator Identifier, | Management_ |
| | | | or a DNN with the Network Identifier only. | Enhancement |
| | | | (Note 1) | |
| monitoringType | MonitoringType | 1 | Enumeration of monitoring type. Refer to | |
| | | | clause 5.3.2.4.3. | |
| maximumNumberOfReports | integer | 0 . . . 1 | Identifies the maximum number of | |
| | | | event reports to be generated by | |
| | | | the HSS, MME/SGSN as specified | |
| | | | in subclause 5.6.0 of 3GPP TS 23.682 [2]. | |
| monitorExpireTime | DateTime | 0 . . . 1 | Identifies the absolute time at | |
| | | | which the related monitoring event | |
| | | | request is considered to expire, as | |
| | | | specified in subclause 5.6.0 of | |
| | | | 3GPP TS 23.682 [2]. | |
| repPeriod | DurationSec | 0 . . . 1 | Identifies the periodic time for the event | |
| | | | reports. | |
| groupReportGuardTime | DurationSec | 0 . . . 1 | Identifies the time for which the SCEF can | |
| | | | aggregate the monitoring event reports | |
| | | | detected by the UEs in a group and report | |
| | | | them together to the SCS/AS, as specified | |
| | | | in subclause 5.6.0 of 3GPP TS 23.682 [2]. | |
| monitoringEventReport | MonitoringEventReport | 0 . . . 1 | Identifies a monitoring event report which | |
| | | | is sent from the SCEF to the SCS/AS. | |
| apiNames | array(string) | 0 . . . N | If “monitoringType” is | API_support_ |
| | | | “API_SUPPORT_CAPABILITY”, this | capability_ |
| | | | parameter may be included. Each element | notification |
| | | | identifies the name of an API. | |
| | | | It shall set as {apiName} part of the URI | |
| | | | structure for each T8 or N33 API as | |
| | | | defined in the present specification or | |
| | | | 3GPP TS 29.522 [62], respectively. | |
| | | | This allows the SCS/AS to request the | |
| | | | capability change for its interested APIs. If | |
| | | | it is omitted, the SCS/AS requests to be | |
| | | | notified for capability change for all APIs | |
| | | | the SCEF + NEF supports. | |
| Snssai | Snssai | 0 . . . 1 | Indicates the S-NSSAI that the event | NSAC, |
| | | | monitoring subscription is targeting. | Session_ |
| | | | This attribute shall be provided if the | Management_ |
| | | | “monitoring Type” attribute is set to | Enhancement |
| | | | “NUM_OF_REGD_UES”, | |
| | | | “NUM_OF_ESTD_PDU_SESSIONS” or | |
| | | | “PDN_CONNECTIVITY_STATUS”. | |
| | | | (Note 1) | |

(NOTE 1):
One of the properties “externalId”, “msisdn”, “ipv4Addr”, “ipv6Addr” or “externalGroupId” shall be included for features “Location_notification” and “Communication_failure_notification”;. One of the properties “externalId”, “msisdn” or “externalGroupId” shall be included for feature “eLCS”. “ipv4Addr” or “ipv6Addr” is required for monitoring via the PCRF for an individual UE. One of the properties “externalId”, “msisdn” or “externalGroupId” shall be included for features “Pdn_connectivity_status”, “Loss_of_connectivity_notification”, “ Ue-reachability_notification”, “Change_of_IMSI_IMEI_association_notification”, “Roaming_status_notification”, “Availability_after_DDN—failure_notification” and “Availability_after_DDN_failure_notification_enhancement”. One of the properties “externalId”, “msisdn”, “externalGroupId” and/or any of “dnn” and “snssai”, shall be included for feature “Session_Management_Enhancement”. If only any of “dnn” and “snssai” is included then any UE within the DNN and/or S-NSSAI is applicable.

As may be seen from table 3, in an embodiment, the attribute “dnn” with the data type “Dnn”, which may be applicable to new feature e.g. Session_Management_Enhancement feature, may be added into the Definition of type MonitoringEventSubscription for identifying a DNN. In an embodiment, the identified DNN may be a full DNN with both the Network Identifier and Operator Identifier, or a DNN with the Network Identifier only.

Furthermore, as may be seen from table 3, in an embodiment, the attribute “snssai” with the data type “Snssai” in the Definition of type MonitoringEventSubscription, which may be used for indicating the S-NSSAI that the event monitoring subscription is targeting, now also may be applicable to Session_Management_Enhancement feature.

In an embodiment, an example of the data type PdnConnectionInformation in MonitoringEvent API is shown in the following table 4.

TABLE 4
Definition of type PdnConnectionInformation

| | | | | |
|---|---|---|---|---|
| Attribute name | Data type | Cardinality | Description | Applicability |

| | | | |
|---|---|---|---|
| status | PdnConnectionStatus | 1 | Identifies the PDN connection status. |
| apn | string | 0 . . . 1 | Identifies the APN, it is depending on the |
| | | | SCEF local configuration whether or not |
| | | | this attribute is sent to the SCS/AS. |
| pdnType | PdnType | 1 | PDN type |
| interfaceInd | InterfaceIndication | 0 . . . 1 | Identifies the 3GPP network function |
| | | | used to communicate with the SCS/AS |
| | | | for non-IP PDN type. |
| ipv4Addr | Ipv4Addr | 0 . . . 1 | Identifies the UE Ipv4 address. |
| ipv6Addrs | array(Ipv6Addr) | 0 . . . N | Identifies the UE Ipv6 address. |
| snssai | Snssai | 0 . . . 1 | Identifies the S-NSSAI. |

As may be seen from table 4, in an embodiment, the attribute “snssai” with the data type “Snssai” may be added into the Definition of type PdnConnectionInformation for identifying the S-NSSAI.

5

In an embodiment, an example of features used by MonitoringEvent API is shown in the following table 5.

TABLE 5
Features used by MonitoringEvent API

| Feature | | |
|---|---|---|
| Number | Feature | Description |
| 1 | Loss_of_connectivity_notification | The SCS/AS is notified when the 3GPP network |
| | | detects that the UE is no longer reachable for |
| | | signalling or user plane communication |
| 2 | Ue-reachability_notification | The SCS/AS is notified when the UE becomes |
| | | reachable for sending either SMS or downlink data to |
| | | the UE |
| 3 | Location_notification | The SCS/AS is notified of the current location or the |
| | | last known location of the UE |
| 4 | Change_of_IMSI_IMEI_association_ | The SCS/AS is notified when the association of an |
| | notification | ME (IMEI(SV)) that uses a specific subscription (IMSI) |
| | | is changed |
| 5 | Roaming_status_notification | The SCS/AS is notified when the UE's roaming status |
| | | changes |
| 6 | Communication_failure_notification | The SCS/AS is notified of communication failure |
| | | events |
| 7 | Availability_after_DDN_failure_ | The SCS/AS is notified when the UE has become |
| | notification | available after a DDN failure |
| 8 | Number_of_UEs_in_an_area_notification | The SCS/AS is notified the number of UEs present in |
| | | a given geographic area |
| | | The feature supports pre-5G (e.g. 4G) requirement. |
| 9 | Notification_websocket | The delivery of notifications over Websocket is |
| | | supported according to subclause 5.2.5.4. This |
| | | feature requires that the Notification_test_event |
| | | featute is also supported. |
| 10 | Notification_test_event | The testing of notification connection is supported |
| | | according to subclause 5.2.5.3. |
| 11 | Subscription_modification | Modifications of an individual subscription resource. |
| 12 | Number_of_UEs_in_an_area_notification_5G | The AF is notified the number of UEs present in a |
| | | given geographic area. |
| | | The feature supports the 5G requirement. This feature |
| | | may only be supported in 5G. |
| 13 | Pdn_connectivity_status | The SCS/AS requests to be notified when the 3GPP |
| | | network detects that the UE's PDN connection is set |
| | | up or torn down. |
| 14 | Downlink_data_delivery_status_5G | The AF requests to be notified when the 3GPP |
| | | network detects that the downlink data delivery status |
| | | is changed. The feature is not applicable to pre-5G. |
| 15 | Availability_after_DDN_failure_ | The AF is notified when the UE has become available |
| | notification_enhancement | after a DDN failure and the traffic matches the packet |
| | | filter provided by the AF. The feature is not applicable |
| | | to pre-5G. |
| 16 | Enhanced_param_config | This feature supports the co-existence of multiple |
| | | event configurations for target UE(s) if there are |
| | | parameters affecting periodic RAU/TAU timer and/or |
| | | Active Time. Supporting this feature also requires the |
| | | support of feature number 1 or 2. |
| 17 | API_support_capability_notification | The SCS/AS is notified of the availability of support of |
| | | service APIs. This feature is only applicable in |
| | | interworking SCEF + NEF scenario. |
| 18 | eLCS | This feature supports the enhanced location exposure |
| | | service (e.g. location information preciser than cell |
| | | level). |
| | | The feature is not applicable to pre-5G (e.g. 4G). |
| 19 | NSAC | This feature controls the support of the Network Slice |
| | | Admission Control (NSAC) functionalities. |
| | | The feature is not applicable to pre-5G (e.g. 4G). |
| 20 | Partial_group_cancellation | This feature supports the partial cancellation to the |
| | | partial group member(s) within the grouped event |
| | | monitoring subscription. |
| M | Session_Management_Enhancement | This feature supports session management |
| | | enhancement with requested DNN and/or |
| | | S-NSSAI. This feature requires that the |
| | | Pdn_connectivity_status feature and/or |
| | | Downlink_data_delivery_status_5G feature is also |
| | | supported. |

Feature: A short name that can be used to refer to the bit and to the feature, e.g. “Notification”.
Description: A clear textual description of the feature.

As may be seen from table 5, in an embodiment, the feature “Session_Management_Enhancement” may be added into the Features used by the MonitoringEvent API for session management enhancement with the requested DNN and/or S-NSSAI. This feature “Session_Management_Enhancement” requires that the Pdn_connectivity_status feature and/or Downlink_data_delivery_status_5G is also supported.

In an embodiment, in particular, the “dnn: $ref: ‘TS29571_CommonData.yaml#/components/schemas/Dnn’” and “snssai: $ref: ‘TS29571_CommonData.yaml#/components/schemas/Snssai’” may be added into the MonitoringEvent API.

In an embodiment, an example of NsmfEventExposure is shown in the following table 6.

TABLE 6
Definition of type NsmfEventExposure

| Attribute name | Data type | P | Cardinality | Description | Applicability |
|---|---|---|---|---|---|
| Supi | Supi | C | 0 . . . 1 | Subscription Permanent Identifier | |
| | | | | (NOTE 1) | |
| Gpsi | Gpsi | C | 0 . . . 1 | Generic Public Subscription | |
| | | | | Identifier (NOTE 1) | |
| anyUeInd | boolean | C | 0 . . . 1 | This IE shall be present if the event | |
| | | | | subscription is applicable to any UE. | |
| | | | | Default value “false” is used, if not | |
| | | | | present (NOTE 1), (NOTE x) | |
| groupId | GroupId | C | 0 . . . 1 | Identifies a group of UEs. (NOTE 1), | |
| | | | | (NOTE x) | |
| pduSeId | PduSessionId | C | 0 . . . 1 | PDU session ID (NOTE 1) | |
| Dnn | Dnn | O | 0 . . . 1 | Data Network Name. (NOTE x) | |
| Snssai | Snssai | O | 0 . . . 1 | A single Network Slice Selection | |
| | | | | Assistance Information. (NOTE x) | |
| subId | SubId | C | 0 . . . 1 | Subscription ID. | |
| | | | | This parameter shall be supplied by | |
| | | | | the SMF in HTTP responses that | |
| | | | | include an object of | |
| | | | | NsmfEventExposure type. | |
| notifId | string | M | 1 | Notification Correlation ID provided | |
| | | | | by the NF service consumer. | |
| | | | | (NOTE 2) | |
| notifUri | Uri | M | 1 | Identifies the recipient of | |
| | | | | Notifications sent by the SMF. | |
| altNotifIpv4Addrs | array(Ipv4Addr) | O | 1 . . . N | Alternate or backup IPv4 | |
| | | | | Address(es) where to send | |
| | | | | Notifications. | |
| altNotifIpv6Addrs | array(Ipv6Addr) | O | 1 . . . N | Alternate or backup IPv6 | |
| | | | | Address(es) where to send | |
| | | | | Notifications. | |
| altNotifFqdns | array(Fqdn) | O | 1 . . . N | Alternate or backup FQDN(s) where | |
| | | | | to send Notifications. | |
| eventSubs | array(EventSubscription) | M | 1 . . . N | Subscribed events | |
| ImmeRep | Boolean | O | 0 . . . 1 | It is included and set to true if the | |
| | | | | immediate reporting of the current | |
| | | | | status of the subscribed event, if | |
| | | | | available is required. | |
| notifMethod | NotificationMethod | O | 0 . . . 1 | If “notifMethod” is not supplied, the | |
| | | | | default value | |
| | | | | “ON_EVENT_DETECTION” applies. | |
| maxReportNbr | Uinteger | O | 0 . . . 1 | If omitted, there is no limit. | |
| Expiry | DateTime | C | 0 . . . 1 | This attribute indicates the expiry | |
| | | | | time of the subscription, after which | |
| | | | | the SMF shall not send any event | |
| | | | | notifications and the subscription | |
| | | | | becomes invalid. It may be included | |
| | | | | in an event subscription request and | |
| | | | | may be included in an event | |
| | | | | subscription response based on | |
| | | | | operator policies. If an expiry time | |
| | | | | was included in the request, then | |
| | | | | the expiry time returned in the | |
| | | | | response should be less than or | |
| | | | | equal to that value. If the expiry time | |
| | | | | is not included in the response, the | |
| | | | | NF service consumer shall not | |
| | | | | associate an expiry time for the | |
| | | | | subscription. | |
| repPeriod | DurationSec | C | 0 . . . 1 | Is supplied for notification Method | |
| | | | | “periodic”. | |
| Guami | Guami | C | 0 . . . 1 | The Globally Unique AMF Identifier | |
| | | | | (GUAMI) shall be provided by an | |
| | | | | AMF as NF service consumer. | |
| serviceName | ServiceName | O | 0 . . . 1 | If the NF service consumer is an | |
| | | | | AMF, it should provide the name of | |
| | | | | a service produced by the AMF that | |
| | | | | makes use of the notification about | |
| | | | | subscribed events. | |
| supportedFeatures | SupportedFeatures | C | 0 . . . 1 | List of Supported features used as | |
| | | | | described in subclause 5.8. | |
| | | | | This parameter shall be supplied by | |
| | | | | NF service consumer and SMF in | |
| | | | | the POST request that request the | |
| | | | | creation of an SMF Notification | |
| | | | | Subscriptions resource and the | |
| | | | | related reply, respectively. | |
| sampRatio | Sampling Ratio | O | 0 . . . 1 | Indicates the ratio of the random | |
| | | | | subset to target UEs, event reports | |
| | | | | only relates to the subset. | |
| partitionCriteria | array(PartitioningCriteria) | O | 1 . . . N | Defines criteria for partitioning the | EneNA |
| | | | | UEs in order to apply the sampling | |
| | | | | ratio for each partition. It may only | |
| | | | | be included in event subscription | |
| | | | | requests when the “sampRatio” | |
| | | | | attribute is also provided. (NOTE 3) | |
| grpRepTime | DurationSec | O | 0 . . . 1 | Indicates the time for which the SMF | |
| | | | | aggregates the event reports | |
| | | | | detected by the UEs in a group and | |
| | | | | report them together to the NF | |
| | | | | service consumer. | |
| notifFlag | NotificationFlag | O | 0 . . . 1 | Indicates the notification flag, which | EneNA |
| | | | | is used to mute/unmute notifications | |
| | | | | and to retrieve events stored during | |
| | | | | a period of muted notifications. | |
| | | | | Default: “ACTIVATE” | |

(NOTE 1):
If the event subscription applies for a specific PDU session, the PDU session of a single UE (pduSeId, and gpsi/supi) shall be included; otherwise one and only one of a single UE (gpsi/supi), a group of UEs (groupId), or anyUeInd set to true shall be included.
(NOTE 2):
If the UDM as NF service consumer subscribes to event (e.g. downlink data delivery status, PDU Session Establishment, PDU Session Release) on behalf of AF/NEF, “notifId” shall be set the same as “referenceId” received from the AF/NEF as defined in subclause 6.4.6.2.4 of 3GPP TS 29.503 .
(NOTE 3):
For a given type of partitioning criteria, the UE shall belong to only one single partition as long as it is served by the NF service producer.
(NOTE x):
If a group of UEs(groupId) or anyUeInd set to true is included, any of “dnn” and “snssai” attributes may be included.

2. The NEF 102 may perform an authorization for the external Group Id, the DNN and/or the S-NSSAI based on the local policy. If the single UE is monitored, the NEF 102 may perform an authorization for the external UE ID, the MSISDN, the GPSI, the DNN and/or the S-NSSAI based on the local policy.

3. The NEF 102 may map the External Group Id to an Internal Group Id based on the local policy.

4. The NEF 102 may query the NRF 105 to discover/select the concerned SMF(s) 103 that may serve the specific DNN and/or S-NSSAI.

5. For each of the selected SMF 103, the NEF 102 may invoke the Nsmf_EventExposure_Subscribe service operation to subscribe the PDU_SES_REL event and PDU_SES_EST event for a group of UE (identified by the Internal Group Id derived in step 2) or for a single UE (identified by GPSI derived in step 1) or for any UE, for a specific DN (identified by DNN) and S-NSSAI.

6. The SMF 103 may report corresponding events to the NEF 102 directly via the Nsmf_EventExposure_Notify service operation.

7. The NEF 102 may report PDN_CONNECTIVITY_STATUS events to the AF 101 via Nnef_EventExposure_Notify service operation by sending an HTTP POST message as specified in the MonitoringEvent API. In the embodiments shown in FIG. 3, since the “DNN” and/or “S-NSSAI” is provided in MonitoringEventSubscription data type or the requested external Group Id is translated as the internal Group Id by the NEF local configuration, the NEF 102 may directly invoke the Nsmf_EventExposure service to the serving SMF(s) discovered by an NF discovery procedure or the local configuration in the NEF 102, without interact with the UDM 104.

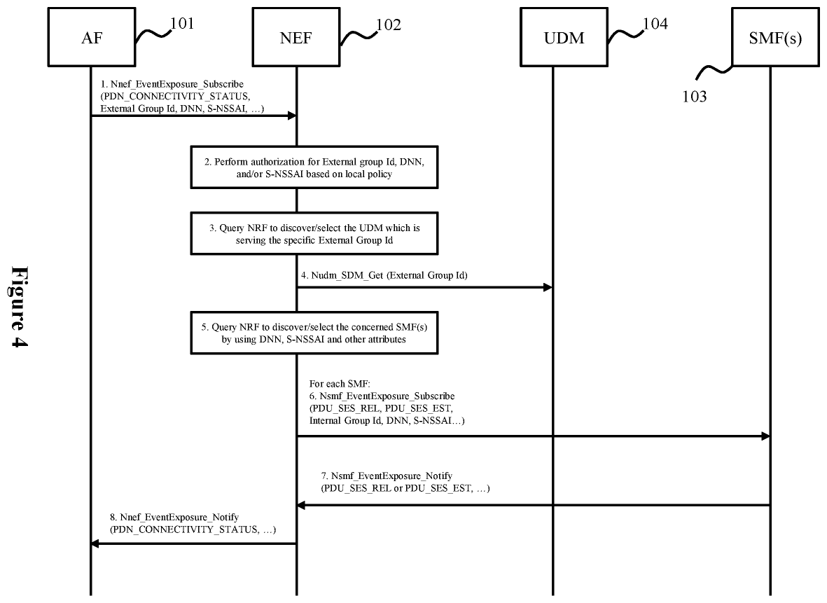

FIG. 4 is another schematic signaling chart showing the messages in the PDN connectivity status subscription procedure, according to the embodiments herein. The signaling in the schematic signaling chart may be implemented in the example 5G network architecture as shown in FIG. 1. Note that, the PDN connectivity status subscription is used here for example, and the similar procedure may be also applicable for other event monitoring, such as downlink data delivery status.

In this schematic signaling chart, the NEF 102 may interact with the UDM 104 for directly subscribing the event(s) on the SMF(s) 103. In an embodiment, the PDN connectivity status subscription procedure may include the following messages or steps:

1. The AF 101 may invoke the Nnef_EventExposure_Subscribe service operation by sending an HTTP POST message as specified in the MonitoringEvent API to monitor the PDN_CONNECTIVITY_STATUS event for a group of UE (identified by External Group Id) or for a single UE (identified by External Id, MSISDN, or GPSI) or for any UE, for a specific DN (identified by DNN) and/or S-NSSAI (optional). In FIG. 4, the External Group Id is used here as an example in the scenario of a group of UEs.

The above examples in table 1 to table 6 may also be applicable for the MonitoringEvent API of FIG. 4.

2. The NEF 102 may perform an authorization for the external Group Id, the DNN and/or the S-NSSAI based on the local policy. If the single UE is monitored, the NEF 102 may perform an authorization for the external UE ID, the MSISDN, the GPSI, the DNN and/or the S-NSSAI based on the local policy.

3. The NEF 102 may query the NRF 102 to perform the Network Function (NF) discovery for the UDM(s) 104 that may serve the specific External Group Id.

4. The NEF 102 may invoke a Nudm_SDM_Get to translate the External Group Id to an Internal Group Id. The Nudm_SDM_Get is further specified in 3GPP TS 29.503, v17.3.0 as Nudm_SubscriberDataManagement_Get.

5. The NEF 102 may query the NRF 105 to discover/select the concerned SMF(s) 103 that may serve the specific DNN and/or S-NSSAI.

6. For each of the selected SMF(s) 103, the NEF 102 may invoke the Nsmf_EventExposure_Subscribe service operation to subscribe the PDU_SES_REL event and PDU_SES_EST event for a group of UE (identified by the Internal Group Id derived in step 2) or for a single UE (identified by GPSI derived in step 2) or for any UE, for a specific DN (identified by DNN) and S-NSSAI.

7. The SMF 103 may report corresponding events to the NEF 102 directly via the Nsmf_EventExposure_Notify service operation.

8. The NEF 102 may report PDN_CONNECTIVITY_STATUS events to the AF 101 via the Nnef_EventExposure_Notify service operation by sending an HTTP POST message as specified in the MonitoringEvent API.

FIG. 5 is yet another schematic signaling chart showing the messages in the PDN connectivity status subscription procedure, according to the embodiments herein. The signaling in the schematic signaling chart may be implemented in the example 5G network architecture as shown in FIG. 1. Note that, the PDN connectivity status subscription is used here for example, the similar procedure may be also applicable for other event monitoring, such as downlink data delivery status.

In this schematic signaling chart, the NEF 102 may interact with the UDM 104 for events subscription on the SMF(s) 103. In an embodiment, the PDN connectivity status subscription procedure may include the following messages or steps:

1. The AF 101 may invoke the Nnef_EventExposure_Subscribe service operation by sending an HTTP POST message as specified in MonitoringEvent API to monitor the PDN_CONNECTIVITY_STATUS event for a group of UE (identified by External Group Id), for a single UE (identified by External Id, MSISDN, or GPSI), or for any UE, for a specific DN (identified by DNN). In FIG. 5, the External Group Id is used here as an example in the scenario of a group of UEs.

If the event subscription is for a single UE, the NEF 102 may derive the GPSI based on the received External Id or MSISDN.

The above examples in table 1 to table 6 may also be applicable for the MonitoringEvent API of FIG. 4.

2. The NEF 102 may query the NRF 105 to perform the NF discovery/selection for the UDM(s) that serves the specific External Group Id or GPSI.

3. The NEF 102 may invoke the Nudm_EventExposure_Subscribe to subscribe the PDN_CONNECTIVITY_STATUS event for a group of UE (identified by External Group Id), for a single UE (identified by GPSI), or for any UE, for the specific DN (identified by DNN). The UDM 104 may create a corresponding event subscription and store the event subscription data in the UDR (if the UDM 104 is a stateless UDM).

4. During the PDU session establishment procedure, the SMF 103 may register with the UDM 104 using a Nudm_UECM_Registration for a given PDU Session.

5. If the UDM 104 has existing applicable event exposure subscriptions for events detected in the SMF 103 for this UE or any of the groups this UE belongs to, (possibly retrieved from the UDR), the UDM 104 may invoke the Nsmf_EventExposure_Subscribe service for creating the event exposure subscriptions.

6. For the SMF 103 registering to the UDM 104 in steps 4 and 5, the UDM 104 may invoke the Nsmf_EventExposure_Subscribe service operation to subscribe the PDU_SES_REL event and PDU_SES_EST event for the group of UE (identified by the External Group Id) if such event subscription is not created on that SMF 103 before.

7. The SMF 103 may report corresponding events to the NEF 102 directly via the Nsmf_EventExposure_Notify service operation.

8. The NEF 102 may report PDN_CONNECTIVITY_STATUS events to the AF 101 via the Nnef_EventExposure_Notify service operation by sending an HTTP POST message as specified in the MonitoringEvent API.

The embodiments shown in FIGS. 3-5 may allow the AF 101 to subscribe the PDN_CONNECTIVITY_STATUS event related to a data network or a 5G virtual network for a group of UE, a single UE, or any UE, via the NEF event exposure API.

The embodiments shown in FIG. 3 may especially provide a way to remove the UDM 104 and UDR (in case of stateless UDM) from the traffic path of PDN_CONNECTIVITY_STATUS event exposure, therefore the event subscription end to end latency and resource consumption/workload of the UDM 104 and UDR can be reduced.

By introducing “DNN” and/or “S-NSSAI” in MonitoringEventSubscription data type for AF, the embodiment may correctly and dynamically provide DNN and/or S-NSSAI subscription request.

If the “Session_Management_Enhancement” feature is supported, when “DNN” and/or “S-NSSAI” is provided in MonitoringEventSubscription data type for the requested external Group Id or any UE, the NEF 102 may, based on the local policy, directly invoke the Nsmf_EventExposure service to the serving SMF(s) 103 discovered by the NRF network function discovery procedure or the local configuration in the NEF 102.

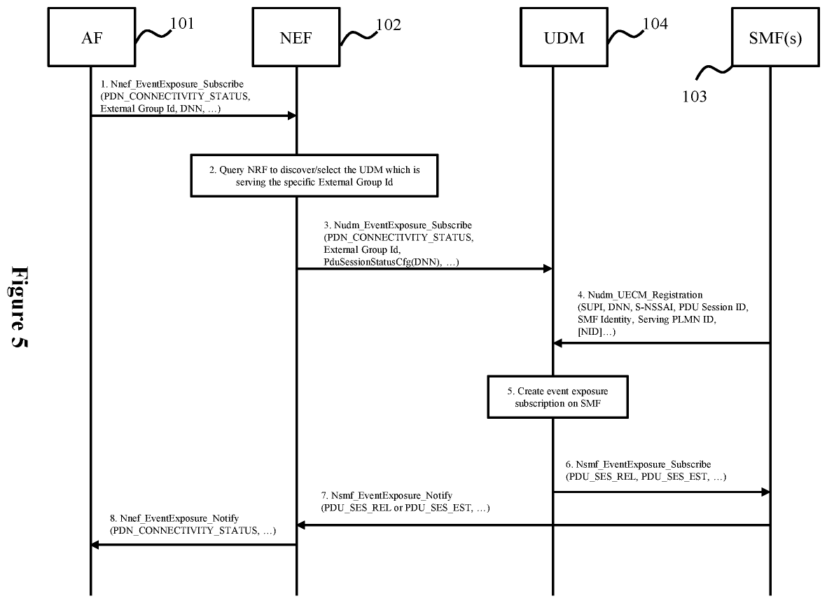

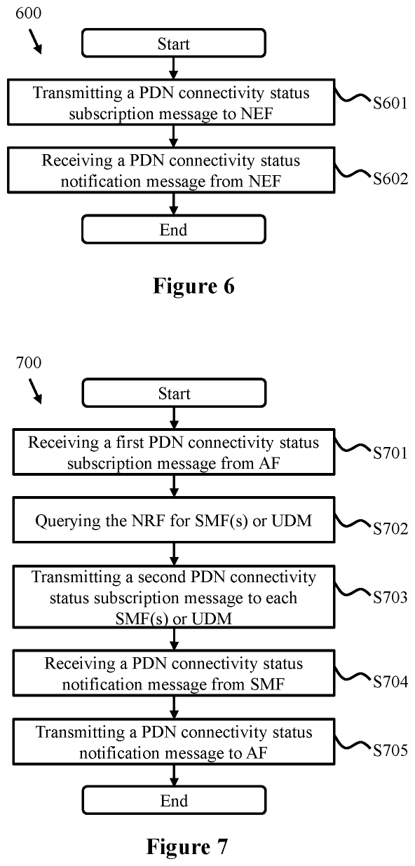

FIG. 6 is a schematic flow chart showing an example method 600 in the first network function, according to the embodiments herein. In an embodiment, the flow chart 600 in FIG. 6 may be implemented in the first network function (such as the AF 101) in FIGS. 3-5. Note that, the PDN connectivity status subscription is used here for example, and the similar procedure may be also applicable for other event monitoring, such as downlink data delivery status.

The method 600 may begin with step S601, in which the first network function may transmit a first subscription message comprising at least one of DNN of a data network and S-NSSAI to a second network function implementing network exposure function (such as the NEF 102), so as to monitor a PDN connectivity status for a UE or a group of UEs. Here, a UE can be a specific UE or any UE.

In an embodiment, the first subscription message may further comprise an external group ID indicating the group of UE. In another embodiment, the first subscription message may further comprise an external UE ID, a MSISDN, or a GPSI indicating a specific UE. In yet another embodiment, the first subscription message may further comprise an indication indicating any UE.

Then, the method 600 may proceed to step S602, in which the first network function may receive a first notification message comprising information indicating the PDN connectivity status from the second network function.

The above steps are only examples, and the first network function may perform any actions described with respect to FIGS. 3-5, to monitor a PDN connectivity status of UE via the PDN connectivity status subscription procedure.

FIG. 7 is a schematic flow chart showing an example method 700 in the second network function, according to the embodiments herein. In an embodiment, the flow chart 700 in FIG. 7 may be implemented in the second network function (such as the NEF 102) in FIGS. 3-5. Note that, the PDN connectivity status subscription is used here for example, the similar procedure may be also applicable for other event monitoring, such as downlink data delivery status.

The method 700 may begin with step S701, in which the second network function may receive a first subscription message comprising at least one of DNN of a data network and S-NSSAI from a first network function implementing application function (such as the AF 101), so as to monitor a PDN connectivity status of a UE or a group of UEs. Here, a UE can be a specific UE or any UE.

In an embodiment, the first subscription message may further comprise an external group ID indicating the group of UE. In another embodiment, the first subscription message may further comprise an external UE ID, a MSISDN, or a GPSI indicating a specific UE. In yet another embodiment, the first subscription message may further comprise an indication indicating any UE.

Then, the method 700 may proceed to step S702, in which the second network function may determine a third network function implementing session management function (such as the SMF 103) or a fourth network function implementing unified data management function (such as the UDM 104) for the PDN connectivity status subscription.

In an embodiment, determining the network function in step S702 may further comprise the step of querying a fifth network function implementing network repository function (such as the NRF 105) for one or more third network functions implementing session management functions (such as the SMF 103) based on the DNN and the S-NSSAI, as shown in FIGS. 3 and 4.

In an embodiment, determining the network function in step S702 may further comprise the step of querying a fifth network function implementing network repository function (such as the NRF 105) for a fourth network function implementing unified data management (such as the UDM 104) based on one of the external group ID, the external UE ID, the MSISDN, or the GPSI, as shown in FIG. 5.

Then, the method 700 may proceed to step S703, in which the second network function may transmit a second subscription message comprising at least one of the DNN and S-NSSAI to the determined network function (the SMF(s) 103 or the UDM 104).

Then, the method 700 may proceed to step S704, in which the second network function may receive a second notification message comprising information indicating the PDN connectivity status from the third network function implementing session management function.

Then, the method 700 may proceed to step S705, in which the second network function may transmit a first notification message comprising information indicating the PDN connectivity status to the first network function.

In addition to the above steps, as shown in FIG. 3, in an embodiment, the method may further comprise the step of translating the external group ID to internal group ID based on a local policy. In another embodiment, the method may further comprise the step of translating the MSISDN or the external UE ID to GPSI based on a local policy.

In an embodiment, as shown in FIG. 4, the method may further comprise the step of querying the fifth network function implementing network repository function for a fourth network function implementing unified data management based on the external group ID. In an embodiment, the method may further comprise the step of transmitting a request comprising external group ID to the fourth network function implementing unified data management. In an embodiment, the method may further comprise the step of receiving the internal group ID from the fourth network function implementing unified data management.

In an embodiment, as shown in FIGS. 3 and 4, the method may further comprise the step of performing, based on a local policy, authorization for at least one of: the external group Id, the DNN, the external UE ID, the MSISDN, the GPSI, or the S-NSSAI.

The above steps are only examples, and the second network function may perform any actions described with respect to FIGS. 3-5, to monitor a PDN connectivity status of UE via the PDN connectivity status subscription procedure.

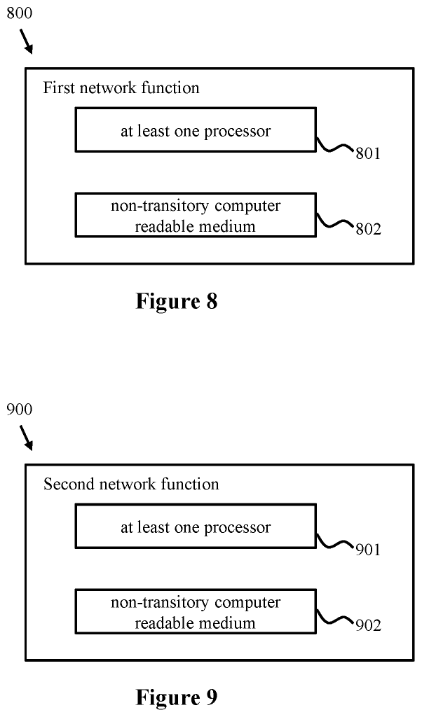

FIG. 8 is a schematic block diagram showing an example first network function (such as the AF 101), according to the embodiments herein.

In an embodiment, the first network function 800 may include at least one processor 801; and a non-transitory computer readable medium 802 coupled to the at least one processor 801. The non-transitory computer readable medium 802 contains instructions executable by the at least one processor 801, whereby the at least one processor 801 is configured to perform the steps in the example method 600 as shown in the schematic flow chart of FIG. 6; the details thereof are omitted here.

Note that, the first network function 800 may be implemented as hardware, software, firmware and any combination thereof. For example, the first network function 800 may include a plurality of units, circuities, modules or the like, each of which may be used to perform one or more steps of the example method 600 or one or more steps shown in FIGS. 3-5 related to the first network function (such as the AF 101).

It should be understood that, the first network function may be implemented either as a network element on a dedicated hardware, as a software instance running on a dedicated hardware, or as a virtualized function instantiated on an appropriate platform, e.g. on a cloud infrastructure.

FIG. 9 is a schematic block diagram showing an example second network function (such as the NEF 102), according to the embodiments herein.

In an embodiment, the second network function 900 may include at least one processor 901; and a non-transitory computer readable medium 902 coupled to the at least one processor 901. The non-transitory computer readable medium 902 contains instructions executable by the at least one processor 901, whereby the at least one processor 901 is configured to perform the steps in the example method 700 as shown in the schematic flow chart of FIG. 7; the details thereof are omitted here.

Note that, the second network function 900 may be implemented as hardware, software, firmware and any combination thereof. For example, the second network function 900 may include a plurality of units, circuities, modules or the like, each of which may be used to perform one or more steps of the example method 700 or one or more steps shown in FIGS. 3-5 related to the second network function (such as the NEF 102).

It should be understood that, the second network function may be implemented either as a network element on a dedicated hardware, as a software instance running on a dedicated hardware, or as a virtualized function instantiated on an appropriate platform, e.g. on a cloud infrastructure.

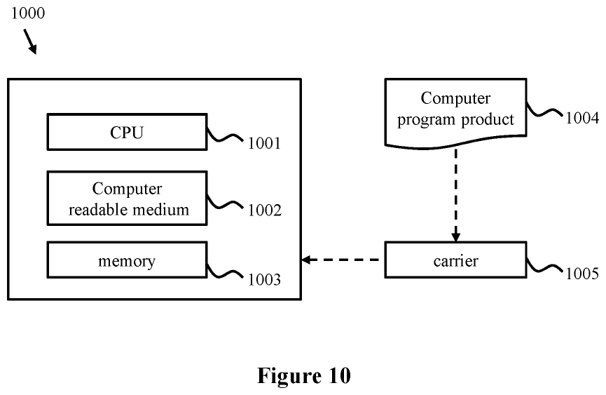

FIG. 10 is a schematic block diagram showing an example computer-implemented apparatus 1000, according to the embodiments herein. In an embodiment, the apparatus 1000 may be configured as the above mentioned apparatus, such as the first network function (such as the AF 101), or the second network function (such as the NEF 102).

In an embodiment, the apparatus 1000 may include but not limited to at least one processor such as Central Processing Unit (CPU) 1001, a computer-readable medium 1002, and a memory 1003. The memory 1003 may comprise a volatile (e.g., Random Access Memory, RAM) and/or non-volatile memory (e.g., a hard disk or flash memory). In an embodiment, the computer-readable medium 1002 may be configured to store a computer program and/or instructions, which, when executed by the processor 1001, causes the processor 1001 to carry out any of the above mentioned methods.

In an embodiment, the computer-readable medium 1002 (such as non-transitory computer readable medium) may be stored in the memory 1003. In another embodiment, the computer program may be stored in a remote location for example computer program product 1004 (also may be embodied as computer-readable medium), and accessible by the processor 1001 via for example carrier 1005.

The computer-readable medium 1002 and/or the computer program product 1004 may be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25,

Internet, Local Area Network (LAN), or similar networks capable of transporting data packets to the infrastructure node).

Furthermore, the following amendments are proposed to amend the current 3GPP Technical Specification.

### Part I: Proposed Amendment for 3GPP TS29.122 V17.2.0

### Title: Update DNN and S-NSSAI in MonitoringEvent API

Reason for change:

TS 23.502 subclause 4.15.3.2.3 step 2 describes “The NEF maps the AF-Identifier into DNN and S-NSSAI combination based on local configuration”, while it's not clear and in many cases not feasible for one AF Identifier mapping to multiple and flexible DNNs and S-NSSAIs combinations.

For monitoring type PDN_CONNECTIVITY_STATUS, which is mapping to the SmfEvent PDU_SES_REL and PDU_SES_EST, DNN, S-NSSAI and any UE is already included in TS 29.508.

Summary of change:

Introducing “dnn” and/or “snssai” in MonitoringEventSubscription data type for AF to directly provide the dnn and/or snssai subscription request, to support Session_Management_Enhancement monitoring map to SMF event exposure.

Consequences if not approved:

DNN and/or S-NSSAI are wrongly mapped in NEF when the AF supporting multiple and flexible DNNs and S-NSSAIs combinations. Not mapping the SMF event exposure for the PDN Connectivity Status monitoring.

Proposed changes:

*** 1st Change *** (the underline indicates the content to be added to the 3GPP Technical Specification)

### 5.3.2.1.1 Introduction

This clause defines data structures to be used in resource representations, including subscription resources.

Table 5.3.2.1.1-1 specifies data types re-used by the MonitoringEvent API from other specifications, including a reference to their respective specifications and when needed, a short description of their use within the MonitoringEvent API.

TABLE 5.3.2.1.1-1
MonitoringEvent API re-used Data Types

| Data type | Reference | Comments |
|---|---|---|
| CivicAddress | 3GPP TS 29.572 [42] | Civic address. |
| CodeWord | 3GPP TS 29.515 [65] | Code word. |
| DIDataDeliveryStatus | 3GPP TS 29.571 [45] | Traffic Descriptor of source of downlink data notifications. |
| DddTrafficDescriptor | 3GPP TS 29.571 [45] | Traffic Descriptor of source of downlink data. |
| Dnn | 3GPP TS 29.571 [45] | Identifies a DNN. |
| GeographicArea | 3GPP TS 29.572 [42] | Identifies the geographical information of the user(s). |
| CivicAddress | 3GPP TS 29.572 [42] | Identifies the civic address information of the user(s). |
| LocationQoS | 3GPP TS 29.572 [42] | Requested location QoS. |
| LdrType | 3GPP TS 29.572 [42] | Location deferred requested event type. |
| VelocityRequested | 3GPP TS 29.572 [42] | Velocity of the target UE requested. |
| AgeOfLocationEstimate | 3GPP TS 29.572 [42] | Age of the location estimate for change of location type or |
| | | motion type of Location deferred report. |
| AccuracyFulfilmentIndicator | 3GPP TS 29.572 [42] | The indication whether the obtained location estimate satisfies |
| | | the requested QoS or not. |
| VelocityEstimate | 3GPP TS 29.572 [42] | UE velocity, if requested and available. |
| LinearDistance | 3GPP TS 29.572 [42] | This IE shall be present and set to true if a location estimate is |
| | | required for motion event report. |
| NetworkAreaInfo | 3GPP TS 29.554 [50] | Identifies a network area information. |
| PositioningMethod | 3GPP TS 29.572 [42] | Identifies the positioning method used to obtain the location |
| | | estimate of the UE. |
| SACEventStatus | 3GPP TS 29.571 [45] | Contains the network slice status information related to network |
| | | slice admission control. |
| SACInfo | 3GPP TS 29.571 [45] | Represents network slice admission control information to |
| | | control the triggering of notifications or convey network slice |
| | | status information. |
| Snssai | 3GPP TS 29.571 [45] | Contains a S-NSSAI. |
| SupportedFeatures | 3GPP TS 29.571 [45] | Used to negotiate the applicability of the optional features |
| | | defined in table 5.3.4-1. |
| ServiceIdentiy | 3GPP TS 29.515 [65] | Service identity. |
| SupportedGADShapes | 3GPP TS 29.572 [42] | Supported Geographical Area Description shapes. |
| TimeWindow | 5.2.1.2.3 | Identifies the time interval. |

*** 2nd Change *** (the underline indicates the content to be added to the 3GPP Technical Specification, and the deletion line indicates the content to be deleted from the 3GPP Technical Specification)

5.3.2.1.2 Type: MonitoringEventSubscription This type represents a subscription to monitoring an event. The same structure is used in the subscription request and subscription response.

TABLE 5.3.2.1.2-1
Definition of type MonitoringEventSubscription

| | | | | Applicability |
|---|---|---|---|---|
| Attribute name | Data type | Cardinality | Description | (NOTE 3) |
| self | Link | 0 . . . 1 | Link to the resource “Individual Monitoring | |
| | | | Event Subscription”. This parameter shall | |
| | | | be supplied by the SCEF in HTTP | |
| | | | responses. | |
| supportedFeatures | SupportedFeatures | 0 . . . 1 | Used to negotiate the supported optional | |
| | | | features of the API as described in | |
| | | | subclause 5.2.7. | |
| | | | This attribute shall be provided in the | |
| | | | POST request and in the response of | |
| | | | successful resource creation. | |
| mtcProviderId | string | 0 . . . 1 | Identifies the MTC Service Provider and/or | |
| | | | MTC Application. (NOTE 7) | |
| externalId | ExternalId | 0 . . . 1 | Identifies a user as defined in Clause 4.6.2 | (NOTE 5) |
| | | | of 3GPP TS 23.682 [2]. (NOTE 1) | |
| msisdn | Msisdn | 0 . . . 1 | Identifies the MS internal PSTN/ISDN | (NOTE 5) |
| | | | number allocated for a UE. (NOTE 1) | |
| externalGroupId | ExternalGroupId | 0 . . . 1 | Identifies a user group as defined in | |
| | | | Clause 4.6.2 of 3GPP TS 23.682 [2]. | |
| | | | (NOTE 1) (NOTE 6) | |
| addExtGroupIds | array(ExternalGroupId) | 0 . . . N | Identifies user groups as defined in Clause | Number_of_UEs_ |
| | | | 4.6.2 of 3GPP TS 23.682 [2]. | in_an_area_ |
| | | | (NOTE 1) (NOTE 6) | notification, |
| | | | | Number_of_UEs_ |
| | | | | in_an_area_ |
| | | | | notification_5G |
| ipv4Addr | Ipv4Addr | 0 . . . 1 | Identifies the Ipv4 address. | Location_ |
| | | | (NOTE 1) | notification, |
| | | | | Communication |
| | | | | failure_ |
| | | | | notification |
| ipv6Addr | Ipv6Addr | 0 . . . 1 | Identifies the Ipv6 address. | Location_ |
| | | | (NOTE 1) | notification, |
| | | | | Communication |
| | | | | failure_ |
| | | | | notification |
| dnn | Dnn | 0 . . . 1 | Identifies a DNN, a full DNN with both the | Session |
| | | | Network Identifier and Operator Identifier, | Management |
| | | | or a DNN with the Network Identifier only. | Enhancement |
| | | | (NOTE 1) (NOTE 8) | |
| notificationDestination | Link | 1 | An URI of a notification destination that T8 | |
| | | | message shall be delivered to. | |
| requestTestNotification | boolean | 0 . . . 1 | Set to true by the SCS/AS to request the | Notification_ |
| | | | SCEF to send a test notification as defined | test_event |
| | | | in subclause 5.2.5.3. Set to false or | |
| | | | omitted otherwise. | |
| websockNotifConfig | WebsockNotifConfig | 0 . . . 1 | Configuration parameters to set up | Notification_ |
| | | | notification delivery over Websocket | websocket |
| | | | protocol as defined in subclause 5.2.5.4. | |
| monitoringType | MonitoringType | 1 | Enumeration of monitoring type. Refer to | |
| | | | clause 5.3.2.4.3. | |
| maximumNumberOfReports | integer | 0 . . . 1 | Identifies the maximum number of event | |
| | | | reports to be generated by the HSS, | |
| | | | MME/SGSN as specified in | |
| | | | subclause 5.6.0 of 3GPP TS 23.682 [2]. | |
| | | | (NOTE 2), (NOTE 9) | |
| monitorExpireTime | DateTime | 0 . . . 1 | Identifies the absolute time at which the | |
| | | | related monitoring event request is | |
| | | | considered to expire, as specified in | |
| | | | subclause 5.6.0 of 3GPP TS 23.682 [2]. | |
| | | | (NOTE 2) | |
| repPeriod | DurationSec | 0 . . . 1 | Identifies the periodic time for the event | |
| | | | reports. (NOTE 8), (NOTE 9), (NOTE 13) | |
| groupReportGuardTime | DurationSec | 0 . . . 1 | Identifies the time for which the SCEF can | |
| | | | aggregate the monitoring event reports | |
| | | | detected by the UEs in a group and report | |
| | | | them together to the SCS/AS, as specified | |
| | | | in subclause 5.6.0 of 3GPP TS 23.682 [2]. | |
| maximumDetectionTime | DurationSec | 0 . . . 1 | If “monitoringType” is | Loss_of_ |
| | | | “LOSS_OF_CONNECTIVITY”, this | connectivity_ |
| | | | parameter may be included to identify the | notification |
| | | | maximum period of time after which the | |
| | | | UE is considered to be unreachable. | |
| reachabilityType | ReachabilityType | 0 . . . 1 | If “monitoringType” is | Ue-reachability_ |
| | | | “UE_REACHABILITY”, this parameter | notification |
| | | | shall be included to identify whether the | |
| | | | request is for “Reachability for SMS” or | |
| | | | “Reachability for Data”. | |
| maximumLatency | DurationSec | 0 . . . 1 | If “monitoringType” is | Ue-reachability_ |
| | | | “UE_REACHABILITY”, this parameter | notification |
| | | | may be included to identify the maximum | |
| | | | delay acceptable for downlink data | |
| | | | transfers. | |
| maximumResponseTime | DurationSec | 0 . . . 1 | If “monitoringType” is | Ue-reachability_ |
| | | | “UE_REACHABILITY”, this parameter | notification |
| | | | may be included to identify the length of | |
| | | | time for which the UE stays reachable to | |
| | | | allow the SCS/AS to reliably deliver the | |
| | | | required downlink data. | |
| suggestedNumberOfDlPackets | integer | 0 . . . 1 | If “monitoringType” is | Ue-reachability- |
| | | | “UE_REACHABILITY”, this parameter | notification |
| | | | may be included to identify the number of | |
| | | | packets that the serving gateway shall | |
| | | | buffer in case that the UE is not reachable. | |
| idleStatusIndication | boolean | 0 . . . 1 | If “monitoringType” is set to | Ue-reachability_ |
| | | | “UE_REACHABILITY” or | notification, |
| | | | “AVAILABILITY_AFTER_DDN_FAILURE”, | Availability_ |
| | | | this parameter may be included to indicate | after_DDN_ |
| | | | the notification of when a UE, for which | failure_ |
| | | | PSM is enabled, transitions into idle mode. | notification, |
| | | | “true”: indicate enabling of notification | Availability_ |
| | | | “false”: indicate no need to notify | after_DDN_ |
| | | | Default: “false”. | failure_ |
| | | | | notification_ |
| | | | | enhancement |
| locationType | LocationType | 0 . . . 1 | If “monitoringType” is | Location_ |
| | | | “LOCATION_REPORTING” or | notification, |
| | | | “NUMBER_OF_UES_IN_AN_AREA”, this | Number_of_UEs_ |
| | | | parameter shall be included to identify | in_an_area_ |
| | | | whether the request is for Current | notification, |
| | | | Location, Initial Location or Last known | Number_of_UEs_ |
| | | | Location. (NOTE 4) | in_an_area_ |
| | | | | notification_ |
| | | | | 5G, eLCS |
| accuracy | Accuracy | 0 . . . 1 | If “monitoringType” is | Location_ |
| | | | “LOCATION_REPORTING”, this | notification, |
| | | | parameter may be included to identify the | eLCS |
| | | | desired level of accuracy of the requested | |
| | | | location information, as described in | |
| | | | subclause 4.9.2 of 3GPP TS 23.682 [2]. | |
| | | | (NOTE 10), (NOTE 11) | |
| | | | For 5G, default value is “TA_RA”. | |
| minimumReportInterval | DurationSec | 0 . . . 1 | If “monitoringType” is | Location_ |
| | | | “LOCATION_REPORTING”, this | notification, |
| | | | parameter may be included to identify a | eLCS |
| | | | minimum time interval between Location | |
| | | | Reporting notifications. | |
| | | | If the “IdrType” attribute is present and set | |
| | | | to “ENTERING_INTO_AREA”. | |
| | | | “LEAVING_FROM_AREA”, | |
| | | | “BEING_INSIDE_AREA” or “MOTION”, | |
| | | | this attribute shall not be included if the | |
| | | | maximumNumberOfReports attribute is | |
| | | | present and set to one time event. | |
| maxRptExpireIntvl | DurationSec | 0 . . . 1 | If “monitoringType” is | eLCS |
| | | | “LOCATION_REPORTING”, this | |
| | | | parameter may be included to identify a | |
| | | | maximum time interval between Location | |
| | | | Reporting notifications. | |
| | | | If the “IdrType” attribute is present and set | |
| | | | to “ENTERING_INTO_AREA”. | |
| | | | “LEAVING_FROM_AREA”, | |
| | | | “BEING_INSIDE_AREA” or “MOTION”, | |
| | | | this attribute shall not be included if the | |
| | | | maximumNumberOfReports attribute is | |
| | | | present and set to one time event. | |
| samplingInterval | DurationSec | 0 . . . 1 | If “monitoringType” is | eLCS |
| | | | “LOCATION_REPORTING”, this | |
| | | | parameter may be included to identify the | |
| | | | maximum time interval between | |
| | | | consecutive evaluations by a UE of a | |
| | | | trigger event. | |
| reportingLocEstInd | boolean | 0 . . . 1 | If “monitoringType” is | eLCS |
| | | | “LOCATION_REPORTING”, this | |
| | | | parameter may be included to indicate | |
| | | | whether event reporting requires the | |
| | | | location information. If set to true, the | |
| | | | location estimation information shall be | |
| | | | included in event reporting. | |
| | | | Default: “false” if omitted. | |
| linearDistance | LinearDistance | 0 . . . 1 | If “monitoringType” is | eLCS |
| | | | “LOCATION_REPORTING”, this | |
| | | | parameter may be included to indicate the | |
| | | | linear(straight line) distance threshold for | |
| | | | motion event reporting. | |
| locQOS | LocationQoS | 0 . . . 1 | If “monitoringType” is | eLCS |
| | | | “LOCATION_REPORTING”, this | |
| | | | parameter may be included to indicate the | |
| | | | expected location QoS requirement for an | |
| | | | immediate MT-LR or deferred MT-LR. | |
| | | | (NOTE 10) | |
| svcId | ServiceIdentity | 0 . . . 1 | If “monitoringType” is | eLCS |
| | | | “LOCATION_REPORTING”, this | |
| | | | parameter may be included to indicate the | |
| | | | service identity of AF. | |
| IdrType | LdrType | 0 . . . 1 | If “monitoringType” is | eLCS |
| | | | “LOCATION_REPORTING”, this | |
| | | | parameter may be included to indicate the | |
| | | | event type for a deferred MT-LR. | |
| velocityRequested | VelocityRequested | 0 . . . 1 | If “monitoringType” is | eLCS |
| | | | “LOCATION_REPORTING”, this | |
| | | | parameter may be included to indicate if | |
| | | | the velocity of the target UE is requested | |
| | | | or not. | |
| maxAgeOfLocEst | AgeOfLocationEstimate | 0 . . . 1 | If “monitoringType” is | eLCS |
| | | | “LOCATION_REPORTING”, this | |
| | | | parameter may be included to indicate | |
| | | | acceptable maximum age of location | |
| | | | estimate. | |
| locTimeWindow | TimeWindow | 0 . . . 1 | If “monitoringType” is | eLCS |
| | | | “LOCATION_REPORTING”, this | |
| | | | parameter may be included to indicate the | |
| | | | starting time and ending time for a | |
| | | | deferred MT-LR. | |
| supportedGADShapes | array(SupportedGADShapes) | 0 . . . N | Supported Geographical Area Description | eLCS |
| | | | shapes. | |
| codeWord | CodeWord | 0 . . . 1 | Code word. | eLCS |
| associationType | AssociationType | 0 . . . 1 | If “monitoringType” is | Change_of_IMSI_ |
| | | | “CHANGE_OF_IMSI_IMEI_ | IMEI_association_ |
| | | | ASSOCIATION”, this parameter shall | notification |
| | | | be included to identify whether the | |
| | | | change of IMSI-IMEI or IMSI-IMEISV | |
| | | | association shall be detected. | |
| plmnIndication | boolean | 0 . . . 1 | If “monitoringType” is | Roaming_status_ |
| | | | “ROAMING_STATUS”, this parameter | notification |
| | | | may be included to indicate the notification | |
| | | | of UE's Serving PLMN ID. | |
| | | | “true”: The value shall be used to | |
| | | | indicate enabling of notification; | |
| | | | “false”: The value shall be used to | |
| | | | indicate disabling of notification. | |
| | | | Default: “false”. | |
| locationArea | LocationArea | 0 . . . 1 | If “monitoringType” is | Number_of_UEs_ |
| | | | “NUMBER_OF_UES_IN_AN_AREA”, this | in_an_area_ |
| | | | parameter may be included to indicate the | notification |
| | | | area within which the SCS/AS requests | |
| | | | the number of UEs. | |
| locationArea5G | LocationArea5G | 0 . . . 1 | If “monitoringType” is | Number_of_UEs_ |
| | | | “NUMBER_OF_UES_IN_AN_AREA”, this | in_an_area_ |
| | | | parameter may be included to indicate the | notification_5G, |
| | | | area within which the AF requests the | eLCS |
| | | | number of UEs. | |
| | | | If “monitoringType” is | |
| | | | “LOCATION_REPORTING”, this | |
| | | | parameter may be included to indicate the | |
| | | | area within which the AF requests the | |
| | | | area event of the target UE. (NOTE 12) | |
| dddTraDescriptors | array(DddTrafficDescriptor) | 0 . . . N | The traffic descriptor(s) of the downlink | Downlink_data_ |
| | | | data source. May be included for event | delivery_status_ |
| | | | “DOWNLINK_DATA_DELIVERY_ | 5G, Availability_ |
| | | | STATUS” or “AVAILABILITY_ | after_DDN_ |
| | | | AFTER_DDN_FAILURE”. | failure_ |
| | | | | notification_ |
| | | | | enhancement |
| dddStati | array(DIDataDeliveryStatus) | 0 . . . N | May be included for event | Downlink_data_ |
| | | | “DOWNLINK_DATA_DELIVERY_STATUS”. | delivery_status_5G |
| | | | The subscribed stati (delivered, | |
| | | | transmitted, buffered) for the event. If | |
| | | | omitted all stati are subscribed. | |
| monitoringEventReport | MonitoringEventReport | 0 . . . 1 | Identifies a monitoring event report which | |
| | | | is sent from the SCEF to the SCS/AS. | |
| apiNames | array(string) | 0 . . . N | If “monitoringType” is | API_support_ |
| | | | “API_SUPPORT_CAPABILITY”, this | capability_ |
| | | | parameter may be included. Each element | notification |
| | | | identifies the name of an API. | |
| | | | It shall set as {apiName} part of the URI | |
| | | | structure for each T8 or N33 API as | |
| | | | defined in the present specification or | |
| | | | 3GPP TS 29.522 [62], respectively. | |
| | | | This allows the SCS/AS to request the | |
| | | | capability change for its interested APIs. If | |
| | | | it is omitted, the SCS/AS requests to be | |
| | | | notified for capability change for all APIs | |
| | | | the SCEF + NEF supports. | |
| tgtNsThreshold | SACInfo | 0 . . . 1 | Indicates the monitoring threshold value, | NSAC |
| | | | for the network slice indentified by the | |
| | | | “snssai” attirbute, upon which event | |
| | | | notification(s) are triggered. | |
| | | | This attribute shall be provided if the | |
| | | | “monitoringType” attribute is set to | |
| | | | “NUM_OF_REGD_UES” or | |
| | | | “NUM_OF_ESTD_PDU_SESSIONS”. | |
| | | | (NOTE 13) | |
| snssai | Snssai | 0 . . . 1 | Indicates the S-NSSAI that the event | NSAC, |
| | | | monitoring subscription is targeting. | Session |
| | | | This attribute shall be provided if the | Management |
| | | | “monitoringType” attribute is set to | Enhancement |
| | | | “NUM_OF_REGD_UES”, [symbol] | |
| | | | “NUM_OF_ESTD_PDU_SESSIONS” or | |
| | | | “PDN CONNECTIVITY STATUS”. | |
| | | | (NOTE 1) (NOTE 8) | |

(NOTE 1):
One of the properties “externalId”, “msisdn”, “ipv4Addr”, “ipv6Addr” or “externalGroupId” shall be included for features “Location_notification” and “Communication_failure_notification”;. One of the properties “externalId”, “msisdn” or “externalGroupId” shall be included for feature “eLCS”. “ipv4Addr” or “ipv6Addr” is required for monitoring via the PCRF for an individual UE. One of the properties “externalId”, “msisdn” or “externalGroupId” shall be included for features “Pdn_connectivity_status”, “Loss—of_connectivity_notification”, “Ue-reachability_notification”, “Change_of_IMSI_IMEI_association_notification”, “Roaming_status_notification”, “Availability_after_DDN_ failure_notification” and “Availability_after_DDN_failure_notification_enhancement”. One of the properties “externalId”, “msisdn”, “ externalGroupId” and/or any of “dnn” and “snssai”, shall be included for feature “Session Management Enhancement”. If only any of “dnn” and “snssai” is included then any UE within the DNN and/or S-NSSAI is applicable,
(NOTE 2):
Inclusion of either “maximumNumberOfReports” (with a value higher than 1) or “monitorExpireTime” makes the Monitoring Request a Continuous Monitoring Request, where the SCEF sends Notifications until either the maximum number of reports or the monitoring duration indicated by the property “monitorExpireTime” is exceeded. The “maximumNumberOfReports” with a value 1 makes the Monitoring Request a One-time Monitoring Request. At least one of “maximumNumberOfReports” or “monitorExpireTime” shall be provided.
(NOTE 3):
Properties marked with a feature as defined in subclause 5.3.4 are applicable as described in subclause 5.2.7. If no features are indicated, the related property applies for all the features.
(NOTE 4):
In this release, for features “Number_of_UEs_in_an_area_notification” and “Number_of_UEs_in_an_area_notification_5G”, locationType shall be set to “LAST_KNOWN_LOCATION”. For 5G, if the “locationType” attribute sets to “LAST_KNOWN_LOCATION”, the “maximumNumberOfReports” attribute shall set to 1 as a One-time Monitoring Request.
(NOTE 5):
The property does not apply for the features “Number_of_UEs_in_an_area_notification” and “Number_of_UEs_in_an_area_notification_5G”.
(NOTE 6):
For the features “Number_of_UEs_in_an_area_notification” and “Number_of_UEs_in_an_area_notification_5G”, the property “externalGroupId” may be included for single group and “addExtGroupIds” may be included for multiple groups but not both.
(NOTE 7):
The SCEF should check received MTC provider identifier and then the SCEF may:
override it with local configured value and send it to HSS;
send it directly to the HSS; or
reject the monitoring configuration request.
(NOTE 8):
This property is only applicable for the NEF.
(NOTE 9):
The value of the “maximumNumberOfReports” attribute sets to 1 and the “repPeriod” attribute are mutually exclusive.
(NOTE 10):
For the eLCS feature, the “accurancy” attribute and “locQoS” attribute are mutually exclusive, and only the “GEO_AREA” value is applicable for the“accurancy” attribute.
(NOTE 11):
The value of “TWAN_ID” is only applicable when the monitoring subscription is via the PCRF as described in subclause 4.4.2.2.4.
(NOTE 12):
For the eLCS feature, only the “geographicAreas” attribute within the “locationArea5G” attribute is applicable.
(NOTE 13):
For the NSAC feature, the “repPeriod” attribute and the “tgtNsThreshold” attribute are mutually exclusive.
Editor's Note:
It is FFS whether an AF can request to subscribe to be notified of both the current number of registered UEs and the current number of established PDU Sessions for a network slice during a subscription to network slice information reporting.
Editor's Note:
It is FFS whether a reporting type (i.e. periodical or threshold based) attribute is needed during a subscription to network slice information reporting.

*** 3rd Change *** (the underline indicates the content to be added to the 3GPP Technical Specification)

### 5.3.2.3.7 Type: PdnConnectionInformation

This data type represents the PDN connection information of the UE.

TABLE 5.3.2.3.7-1
Definition of type PdnConnectionInformation

| | | | | |
|---|---|---|---|---|
| | | | | Applicability |
| Attribute name | Data type | Cardinality | Description | (NOTE 1) |

| | | | |
|---|---|---|---|
| status | PdnConnectionStatuS | 1 | Identifies the PDN connection status. |
| apn | string | 0 . . . 1 | Identifies the APN, it is depending on the |
| | | | SCEF local configuration whether or not |
| | | | this attribute is sent to the SCS/AS. |
| pdnType | PdnType | 1 | PDN type |
| interfaceInd | InterfaceIndication | 0 . . . 1 | Identifies the 3GPP network function |
| | | | used to communicate with the SCS/AS |
| | | | for non-IP PDN type. |
| ipv4Addr | Ipv4Addr | 0 . . . 1 | Identifies the UE Ipv4 address. |
| ipv6Addrs | array(Ipv6Addr) | 0 . . . N | Identifies the UE Ipv6 address. (NOTE 2) |
| snssai | Snssai | 0 . . . 1 | Identifies the S-NSSAI. |

NOTE 1:
Properties marked with a feature as defined in subclause 5.5.4 are applicable as described in subclause 5.2.7. If no features are indicated, the related property applies for all the features.
NOTE 2:
ipv6 prefix is included in this attribute if ipv6 full address is not available.

*** 4th Change *** (the underline indicates the content to be added to the 3GPP Technical Specification)

### 5.3.4 Used Features

The table below defines the features applicable to the MonitoringEvent API. Those features are negotiated as described in subclause 5.2.7.

TABLE 5.3.4-1
Features used by MonitoringEvent API

| Feature | | |
|---|---|---|
| Number | Feature | Description |
| 1 | Loss_of_connectivity_notification | The SCS/AS is notified when the 3GPP network |
| | | detects that the UE is no longer reachable for |
| | | signalling or user plane communication |
| 2 | Ue-reachability_notification | The SCS/AS is notified when the UE becomes |
| | | reachable for sending either SMS or downlink data to |
| | | the UE |
| 3 | Location_notification | The SCS/AS is notified of the current location or the |
| | | last known location of the UE |
| 4 | Change_of_IMSI_IMEI_association_notification | The SCS/AS is notified when the association of an |
| | | ME (IMEI(SV)) that uses a specific subscription (IMSI) |
| | | is changed |
| 5 | Roaming_status_notification | The SCS/AS is notified when the UE's roaming status |
| | | changes |
| 6 | Communication_failure_notification | The SCS/AS is notified of communication failure |
| | | events |
| 7 | Availability_after_DDN_failure_notification | The SCS/AS is notified when the UE has become |
| | | available after a DDN failure |
| 8 | Number_of_UEs_in_an_area_notification | The SCS/AS is notified the number of UEs present in |
| | | a given geographic area |
| | | The feature supports pre-5G (e.g. 4G) requirement. |
| 9 | Notification_websocket | The delivery of notifications over Websocket is |
| | | supported according to subclause 5.2.5.4. This |
| | | feature requires that the Notification_test_event |
| | | featute is also supported. |
| 10 | Notification_test_event | The testing of notification connection is supported |
| | | according to subclause 5.2.5.3. |
| 11 | Subscription_modification | Modifications of an individual subscription resource. |
| 12 | Number_of_UEs_in_an_area_notification_5G | The AF is notified the number of UEs present in a |
| | | given geographic area. |
| | | The feature supports the 5G requirement. This feature |
| | | may only be supported in 5G. |
| 13 | Pdn_connectivity_status | The SCS/AS requests to be notified when the 3GPP |
| | | network detects that the UE's PDN connection is set |
| | | up or torn down. |
| 14 | Downlink_data_delivery_status_5G | The AF requests to be notified when the 3GPP |
| | | network detects that the downlink data delivery status |
| | | is changed. The feature is not applicable to pre-5G. |
| 15 | Availability_after_DDN_failure_notification_ | The AF is notified when the UE has become available |
| | enhancement | after a DDN failure and the traffic matches the packet |
| | | filter provided by the AF. The feature is not applicable |
| | | to pre-5G. |
| 16 | Enhanced_param_config | This feature supports the co-existence of multiple |
| | | event configurations for target UE(s) if there are |
| | | parameters affecting periodic RAU/TAU timer and/or |
| | | Active Time. Supporting this feature also requires the |
| | | support of feature number 1 or 2. |
| 17 | API_support_capability_notification | The SCS/AS is notified of the availability of support of |
| | | service APIs. This feature is only applicable in |
| | | interworking SCEF + NEF scenario. |
| 18 | eLCS | This feature supports the enhanced location exposure |
| | | service (e.g. location information preciser than cell |
| | | level). |
| | | The feature is not applicable to pre-5G (e.g. 4G). |
| 19 | NSAC | This feature controls the support of the Network Slice |
| | | Admission Control (NSAC) functionalities. |
| | | The feature is not applicable to pre-5G (e.g. 4G). |
| 20 | Partial_group_cancellation | This feature supports the partial cancellation to the |
| | | partial group member(s) within the grouped event |
| | | monitoring subscription. |
| m | Session Management Enhancement | This feature supports session management |
| | | enhancement with requested DNN and/or S-NSSAI. |
| | | This feature requires that the Pdn connectivity status |
| | | feature and/or Downlink data delivery status 5G |
| | | feature is also supported. |

Feature: A short name that can be used to refer to the bit and to the feature, e.g. “Notification”.
Description: A clear textual description of the feature.

***5th Change *** (the underline indicates the content to be added to the 3GPP Technical Specification)

*** End of Changes ***

### Part II: Proposed Amendment for 3GPP TS29.522 V17.2.0

### Title: Updates DNN and S-NSSAI in MonitoringEvent API

Reason for change:

TS 23.502 subclause 4.15.3.2.3 step 2 describes “The NEF maps the AF-Identifier into DNN and S-NSSAI combination based on local configuration”, while it's not clear and in many cases not feasible for one AF Identifier mapping to multiple and flexible DNNs and S-NSSAIs combinations.

For monitoring type PDN_CONNECTIVITY_STATUS, which is mapping to the SmfEvent PDU_SES_REL and PDU_SES_EST, DNN, S-NSSAI and any UE is already included in TS 29.508.

Summary of change:

Introducing “dnn” and/or “snssai” in MonitoringEventSubscription data type for AF to correctly and dynamically provide dnn and/or snssai subscription request, with optional procedure enhancement that NEF may directly invoke Nsmf_EventExposure service for the requested DNN and/or S-NSSAI with group of UE or any UE.

Consequences if not approved:

DNN and S-NSSAI wrongly mapped in NEF when the AF supporting multiple and flexible DNNs and S-NSSAIs combinations. Not mapping the SMF event exposure for the PDN Connectivity Status monitoring.

The event monitoring procedure for group of UE or any UE is not effective with tremendous UDM interactions.

Proposed changes:

*** 1st Change *** (the underline indicates the content to be added to the 3GPP Technical Specification)

### 4.4.2 Procedures for Monitoring

The procedures for monitoring as described in subclause 4.4.2 of 3GPP TS 29.122 [4] shall be applicable in 5GS with the following differences:
description of the SCS/AS applies to the AF;
description of the SCEF applies to the NEF;
description of the HSS applies to the UDM, and the NEF shall interact with the UDM by using Nudm_EventExposure service as defined in 3GPP TS 29.503 [17];
description of the MME/SGSN applies to the AMF, and the NEF shall interact with the AMF by using Namf_EventExposure service as defined in 3GPP TS 29.518 [18];
description about the PCRF is not applicable;
description about the change of IMSI-IMEI (SV) association monitoring event applies to the change of SUPI-PEI association monitoring event;
when “monitoringType” sets to “LOCATION_REPORTING” within the MonitoringEventSubscription data type as defined in subclause 5.3.2.1.2 of 3GPP TS 29.122 [4] during the monitoring event subscription, only “CGI_ECGI”, “TA_RA” and “GEO_AREA” within the Accuracy data type as defined in subclause 5.3.2.4.7 of 3GPP TS 29.122 [4], are applicable for 5G MonitoringEvent API.
after validation of the AF request, the NEF may determine a monitoring expiry time, based on operator policy and take into account the monitoring expire time if included in the request; and the NEF may provide a expiry time (determined by the NEF, UDM or AMF) to the AF even the AF does not provided before.
if the “Loss_of_connectivity_notification” as defined in subclause 5.3.4 of 3GPP TS 29.122 [4] is supported, values 0-5 are not applicable for the lossOfConnectReason attribute within MonitoringEventReport data type, the lossOfConnectReason attribute shall be set to 6 if the UE is deregistered, 7 if the maximum detection timer expires or 8 if the UE is purged.
the AF may include a periodic reporting time indicated by the “repPeriod” attribute within MonitoringEventSubscription data type, which is only applicable for Location_notification and Number_of_UEs_in_an_area_notification_5G features in the NEF.
if the “locationType” attribute sets to “LAST_KNOWN_LOCATION”, the “maximumNumberOfReports” attribute shall set to 1 as a One-time Monitoring Request.
description about the PDN connectivity status event applies to the PDU session status event, the description of the MME/SGSN applies to the SMF during the reporting of monitoring event procedure, the NEF receives the event notification via Nsmf_EventExposure service as defined in 3GPP TS 29.508 [26];
If the “Session_Management_Enhancement” feature as defined in subclause 5.3.4 of 3GPP TS 29.122 [4] is supported, when “dnn” and/or “snssai” is provided in MonitoringEventSubscription data type for the requested external Group Id or any UE, the NEF may base on local policy, directly invoke the Nsmf EventExposure service to the serving SMF(s) discovered by NRF NF discovery procedure or local configuration in NEF.
when sending the UDM/AMF/SMF event report to the AF, the NEF may store the event data in the report in the UDR as part of the data for exposure as specified in 3GPP TS 29.519 by using Nudr_DataRepository service as specified in 3GPP TS 29.504 [20].
If the “Downlink_data_delivery_status_5G” as defined in subclause 5.3.4 of 3GPP TS 29.122 [4] is supported, in order to support the downlink data delivery status notification,
the AF shall send an HTTP POST message to the NEF to the resource “Monitoring Event Subscriptions” as defined in subclause 5.3.3.2 of 3GPP TS 29.122 [4] for creating an subscription or send an HTTP PUT message to the NEF to the resource “Individual Monitoring Event Subscription” as defined in subclause 5.3.3.3 of 3GPP TS 29.122 [4] for updating the subscription with the following difference:
within the MonitoringEventSubscription data structure the AF may additionally include packet filter descriptor(s) within the “dddTraDescriptors” attribute and the list of monitoring downlink data delivery status event(s) within the “dddStati” attribute;
the NEF shall subscribe the events to the appropriate UDM(s) within the network by invoking the Nudm_EventExposure_Subscribe service operation as defined in subclause 5.5.2.2 of 3GPP TS 29.503 [17].
when the NEF receives the event notification as defined in subclause 4.4.2 of 3GPP TS 29.508 [26], the NEF shall send an HTTP POST message to the AF as defined in subclause 4.4.2.3 of 3GPP TS 29.122 [4] with the difference that within each MonitoringEventReport data structure, the NEF shall include:
the downlink data delivery status within the “dddStatus” attribute;
the downlink data descriptor impacted by the downlink data delivery status change within the “dddTraDescriptor” attribute;
the estimated buffering time within the “max WaitTime” attribute if the downlink data delivery status is set to “BUFFERED”;

If the “Availability_after_DDN_failure_notification_enhancement” feature as defined in subclause 5.3.4 of 3GPP TS 29.122 [4] is supported, the AF shall send an HTTP POST message to the NEF to the resource “Monitoring Event Subscriptions” as defined in subclause 5.3.3.2 of 3GPP TS 29.122 [4] for creating an subscription or send an HTTP PUT message to the NEF to the resource “Individual Monitoring Event Subscription” as defined in subclause 5.3.3.3 of 3GPP TS 29.122 [4] for updating the subscription with the difference that within the MonitoringEventSubscription data structure, the AF shall include packet filter descriptions within the “dddTraDescriptors” attribute.
If the “eLCS” feature as defined in subclause 5.3.4 of 3GPP TS 29.122 [4] is supported, the AF may send an HTTP POST message to the NEF to the resource “Monitoring Event Subscriptions” as defined in subclause 5.3.3.2 of 3GPP TS 29.122 [4] for creating an subscription or send an HTTP PUT message to the NEF to the resource “Individual Monitoring Event Subscription” as defined in subclause 5.3.3.3 of 3GPP TS 29.122 [4] for updating the subscription with the following difference:
within the MonitoringEventSubscription data structure, the AF may additionally include location QOS requirement within the “locQoS” attribute, the service identifier with the “svcId” attribute, Location deferred requested event type within the “ldrType” attribute, the validity start time and the validity end time in the “locTimeWindow” attribute, the maximum age of location estimate within the “maxAgeOfLocEst” attribute, the requesting target UE velocity within the “velocityRequested” attribute, the linear distance within the “linearDistance” attribute, the reporting target

UE location estimate indication within the “reportingLocEstInd” attribute, the sampling interval within the “samplingInterval” attribute, the maximum reporting expire interval within the “maxRptExpireIntvl” attribute, the supported GAD shapes within the “supportedGADShapes” attribute, the Code word within the “codeword” attribute, and other attributes as defined in subclause 5.3.2.3.2 of 3GPP TS 29.122 [4] for location information subscription; The MonitoringEventSubscription data structure may also include the “locationArea5G” attribute containing only the “geographicAreas” attribute and the “accuracy” attribute set to the value “GEO_AREA”.
if the NEF identifies the location request precision higher than cell level location accuracy is required based on the “locQos” attribute received, the NEF shall interact with the appropriate GMLC within the network by invoking the Ngmlc_Location_ProvideLocation service operation as defined in subclause 6.1 of 3GPP TS 29.515 [35];
if the location request precision is lower than or equal to cell level, based on implementation, the NEF may interact with the GMLC by invoking the Ngmlc_Location_ProvideLocation service operation as defined in subclause 6.1 of 3GPP TS 29.515 [35]; or retrieve the UE location privacy information from the UDM by using Nudm_SDM service as described in subclause 5.2 of 3GPP TS 29.503 and if the privacy setting is verified, the NEF shall interact with the UDM for the serving AMF address by invoking the Nudm_UECM service as described in subclause 5.3 of 3GPP TS 29.503 [17]. After receiving the serving AMF address from the UDM, the NEF shall interact with the AMF by invoking the Namf_EventExposure_Subscribe service operation as defined in subclause 5.3 of 3GPP TS 29.518 [18]; or may interact with UDM by using Nudm_EventExposure service as defined in subclause 5.5 of 3GPP TS 29.503 and the NEF receives the location event notification from the AMF via Namf_EventExposure service as defined in in subclause 5.5 of 3GPP TS 29.518 [18].

Upon receipt of successful location response from the GMLC or the AMF, the NEF shall create or update the resource and then send an HTTP POST or PUT response to the AF as defined in subclause 4.4.2.3 of 3GPP TS 29.122 [4]. Upon receipt of the location Report from the GMLC or the AMF, the NEF shall determine the monitoring event subscription associated with the corresponding Monitoring Event Report as defined in subclause 4.4.2.3 of 3GPP TS 29.122 [4].

In order to delete a previous active configured monitoring event subscription at the NEF, the AF shall send an HTTP DELETE message to the NEF to the resource “Individual Monitoring Event Subscription” which is received in the response to the request that has created the monitoring events subscription resource. The NEF shall interact with the GMLC or the AMF or the UDM to remove the request, upon receipt of the successful response from the GMLC or the AMF or the UDM, the NEF shall delete the active resource “Individual Monitoring Event Subscription” addressed by the URI and send an HTTP response to the AF with a “204 No Content” status code, or a “200 OK” status code including the monitoring event report if received.
If the “NSAC” feature defined in subclause 5.3.4 of 3GPP TS 29.122 [4] is supported, in order to support the network slice status reporting,
the AF shall send an HTTP POST message to the NEF to the “Monitoring Event Subscriptions” resource as defined in subclause 5.3.3.2.3.4 of 3GPP TS 29.122 [4] for creating a subscription, or send an HTTP PUT message to the NEF to the “Individual Monitoring Event Subscription” resource as defined in subclause 5.3.3.3.3.2 of 3GPP TS 29.122 [4] for updating an existing subscription with the following differences:
within the MonitoringEventSubscription data structure,
a) the concerned network slice identified by the “snssai” attribute shall be provided;
b) the value of the “monitoringType” attribute shall be set to “NUM_OF_REGD_UES” to indicate that the AF requests to be notified of the current number of registered UEs for the network slice or “NUM_OF_ESTD_PDU_SESSIONS” to indicate that the AF requests to be notified of the current number of established PDU Sessions for the network slice; and
c) a targeted reporting threshold within the “tgtNsThreshold” attribute or a reporting periodicity within the “repPeriod” attribute may be provided, wherein, the “tgtNsThreshold” attribute and the “repPeriod” attribute are mutually exclusive;
the NEF shall then further interact with the NSACF to create or update the associated subscription to notifications by invoking the Nnsacf_SliceEventExposure_Subscribe service operation as specified in 3GPP TS 29.536 [47];
when the NEF receives the event report from the NSACF as defined in 3GPP TS 29.536 [47], the NEF shall send an HTTP POST message to the AF as defined in subclause 5.3.3a.2.3 of 3GPP TS 29.122 [4] with the difference that within the MonitoringEventReport data type of the MonitoringNotification data type,
the value of the “monitoringType” attribute shall be set to “NUM_OF_REGD_UES” or “NUM_OF_ESTD_PDU_SESSIONS” as the same value during the HTTP POST or PUT request that created or modified the subscription;
the current network slice status information as the “nSStatusInfo” attribute shall be provided, wherein:
if the event reporting is threshold based (i.e. the “tgtNsThreshold” was provided within the MonitoringEventSubscription data type), the “nSStatusInfo” attribute shall contain a confirmation for reaching the targeted threshold value, i.e. by resending the subscribed threshold value, for the network slice identified by the “snssai” attribute provided during subscription creation;
if the event reporting is periodical (i.e. the “repPeriod” was provided within the MonitoringEventSubscription data type), the “nSStatusInfo” attribute shall provide the current network slice status information, i.e. the current number of registered UEs or the current number of established PDU Sessions for the network slice identified by the “snssai” attribute provided during subscription creation.
the AF shall send an HTTP DELETE message to the NEF to the resource “Individual Monitoring Event Subscription” as defined in subclause 5.3.3.3.3.5 of 3GPP TS 29.122 [4] to delete an existing network slice reporting subscription. Then the NEF shall interact with the NSACF to delete the associated subscription to notifications by invoking the Nnsacf_SliceEventExposure_Unsubscribe service operation as specified in 3GPP TS 29.536 [47].

Editor's Note: It is FFS whether an AF can request to subscribe to be notified of both the the current number of registered UEs and the current number of established PDU Sessions for a network slice during a subscription to network slice information reporting.

Editor's Note: It is FFS whether a reporting type (periodical or threshold based) attribute is needed during a subscription to network slice information reporting.

*** End of Changes ***

### Part III: Proposed Amendment for 3GPP TS29.508 V17.3.0

Title: Updates with DNN and S-NSSAI

Reason for change:

TS 23.502 subclause 4.15.3.2.3 step 2 describes “The NEF maps the AF-Identifier into DNN and S-NSSAI combination based on local configuration”, while it's not clear and in many cases not feasible for one AF Identifier mapping to multiple and flexible DNNs and S-NSSAIs combinations.

For monitoring type PDN_CONNECTIVITY_STATUS, which is mapping to the SmfEvent PDU_SES_REL and PDU_SES_EST, DNN, S-NSSAI and any UE is already included in TS 29.508.

Summary of change:

Introducing “dnn” and/or “snssai” in MonitoringEventSubscription data type for AF to correctly and dynamically provide dnn and/or snssai subscription request, with optional procedure enhancement that NEF may directly invoke Nsmf_EventExposure service for the requested DNN and/or S-NSSAI with group of UE or any UE.

Consequences if not approved:

Not clear description on a group of UE or any UE within DNN and/or S-NSSAI in NsmfEventExposure type for subscription request, risky of massive event exposure signalling impact especially for any UE.

Proposed changes:

*** 1st Change *** (the underline indicates the content to be added to the 3GPP Technical Specification, and the deletion line indicates the content to be deleted from the 3GPP Technical Specification)

### 4.2.3.2 Creating a New Subscription . . .

To subscribe to event notifications, the NF service consumer shall send an HTTP POST request with: “{apiRoot}/nsmf-event-exposure/v1/subscriptions/” as Resource URI and the NsmfEventExposure data structure as request body that shall include:
if the subscription applies to events related to a single PDU session for a UE, the PDU Session ID of that PDU session as “pduSeId” attribute and the UE identification as “supi” or “gpsi” attribute;
if the subscription applies to events not related to a single PDU session, identification of UEs to which the subscription applies via:
a) identification of a single UE by SUPI as “supi” attribute or GPSI as “gpsi” attribute;
b) identification of a group of UE(s) via a “groupId” attribute;
c) identification of any UE via the “anyUeInd” attribute set to true;
ml) identification of a group of UE(s) within an DNN and/or S-NSSAI via a “groupId” attribute and any of “dnn” and “snssai” attributes; or
m2) identification of any UE within an DNN and/or S-NSSAI via the “anyUeInd” attribute set to true and any of “dnn” and “snssai” attributes;

NOTE 1: The identification of any UE does not apply for local breakout roaming scenarios where the SMF is located in the VPLMN and the NF service consumer is located in the HPLMN.
an URI where to receive the requested notifications as “notifUri” attribute;
a Notification Correlation Identifier provided by the NF service consumer for the requested notifications as “notifId” attribute; and
if the NF service consumer is an AMF, the GUAMI encoded as “guami” attribute:
a description of the subscribed events as “eventSubs” attribute that for each event shall include:
a) an event identifier as “event” attribute; and
b) for event UP path change, whether the subscription is for early, late, or early and late notifications of UP path reconfiguration in the “dnaiChgType” attribute;
c) for event “downlink data delivery status”, the traffic descriptor(s) of the downlink data source in the “dddTraDescriptors” attribute;
and that may include:
a) for event “downlink data delivery status”, the subscribed delivery statuses in the “dddStati” attribute; and
b) for event “QFI allocation”, the application identifiers in the “appIds” attribute.

The NsmfEventExposure data structure as request body may also include:
if the NF service consumer is an AMF:
a) the name of a service produced by the AMF that expects to receive the notifications about subscribed events encoded as “serviceName” attribute;
b) Alternate or backup IPv4 Address(es) where to send Notifications encoded as “altNotifIpv4Addrs” attribute;
c) Alternate or backup IPv6 Address(es) where to send Notifications encoded as “altNotifIpv6Addrs” attribute;
d) Alternate or backup FQDN(s) where to send Notifications encoded as “altNotifFqdns” attribute;
A Data Network Name as “dnn” attribute;
A single Network Slice Selection Assistance Information as “snssai” attribute;
Immediate reporting flag as “ImmeRep” attribute;
event notification method (periodic, one time, on event detection) as “notifMethod” attribute;
Maximum Number of Reports as “maxReportNbr” attribute;
Monitoring Duration as “expiry” attribute;
Repetition Period for periodic reporting as “repPeriod” attribute;
sampling ratio as “sampRatio” attribute;
partitioning criteria for partitioning the UEs before performing sampling as “partitionCriteria” attribute if the EneNA feature is supported; and/or
group reporting guard time as “grpRepTime” attribute; and/or
a notification flag as “notifFlag” attribute if the EneNA feature is supported.

Upon the reception of an HTTP POST request with: “{apiRoot}/nsmf-event-exposure/v1/subscriptions/” as Resource URI and NsmfEventExposure data structure as request body, the SMF shall:
create a new subscription;
assign a subscription correlation ID;
select an expiry time that is equal to or less than the expiry time potentially received in the request;
store the subscription;
send an HTTP “201 Created” response with NsmfEventExposure data structure as response body and a Location header field containing the URI of the created individual subscription resource, i.e. “{apiRoot}/nsmf-event-exposure/v1/subscriptions/{subId}”;
if the “ImmeRep” attribute is included and set to true in the request, the SMF shall report the current available value(s) for the subscribed event(s) as defined in subclause 4.2.3.1;
if the sampling ratio attribute, as “sampRatio”, is included in the subscription without a “partitionCriteria” attribute, the SMF shall select a random subset of UEs among the target UEs according to the sampling ratio and only report the event(s) related to the selected subset of UEs. If the “partitionCriteria” attribute is additionally included, then the SMF shall first partition the UEs according to the value of the “partitionCriteria” attribute and then select a random subset of UEs from each partition according to the sampling ratio and only report the event(s) related to the selected subsets of UEs;
when the group reporting guard time attribute, as “grpRepTime”, is included in the subscription, the SMF shall accumulate all the event reports for the target UEs until the group reporting guard time expires. Then the SMF shall notify the NF service consumer using the Nsmf_EventExposure_Notify service operation, as described in subclause 4.2.2.2; and
if the “notifFlag” attribute is included and set to “DEACTIVATE” in the request, the SMF shall mute the event notification and store the available events.

If the SMF received an GUAMI, the SMF may subscribe to GUAMI changes using the AMFStatusChange service operation of the Namf_Communication service specified in 3GPP TS 29.518 [13], and it may use the Nnrf_NFDiscovery Service specified in 3GPP TS 29.510 (using the obtained GUAMI and possibly service name) to query the other AMFs within the AMF set.

*** 2nd Change *** (the underline indicates the content to be added to the 3GPP Technical Specification)

### 5.6.2.2 Type NsmfEventExposure

TABLE 5.6.2.2-1
Definition of type NsmfEventExposure

| Attribute name | Data type | P | Cardinality | Description | Applicability |
|---|---|---|---|---|---|
| supi | Supi | C | 0 . . . 1 | Subscription Permanent Identifier | |
| | | | | (NOTE 1) | |
| gpsi | Gpsi | C | 0 . . . 1 | Generic Public Subscription | |
| | | | | Identifier (NOTE 1) | |
| anyUeInd | boolean | C | 0 . . . 1 | This IE shall be present if the | |
| | | | | event subscription is applicable to | |
| | | | | any UE. Default value “false” is | |
| | | | | used, if not present (NOTE 1), (NOTE x) | |
| groupId | GroupId | C | 0 . . . 1 | Identifies a group of UEs. | |
| | | | | (NOTE 1), (NOTE x) | |
| pduSeId | PduSessionId | C | 0 . . . 1 | PDU session ID (NOTE 1) | |
| dnn | Dnn | O | 0 . . . 1 | Data Network Name. (NOTE x) | |
| snssai | Snssai | O | 0 . . . 1 | A single Network Slice Selection | |
| | | | | Assistance Information. (NOTE x) | |
| subId | SubId | C | 0 . . . 1 | Subscription ID. | |
| | | | | This parameter shall be supplied | |
| | | | | by the SMF in HTTP responses | |
| | | | | that include an object of | |
| | | | | NsmfEventExposure type. | |
| notifId | string | M | 1 | Notification Correlation ID provided | |
| | | | | by the NF service consumer. | |
| | | | | (NOTE 2) | |
| notifUri | Uri | M | 1 | Identifies the recipient of | |
| | | | | Notifications sent by the SMF. | |
| altNotifIpv4Addrs | array(Ipv4Addr) | O | 1 . . . N | Alternate or backup IPv4 | |
| | | | | Address(es) where to send | |
| | | | | Notifications. | |
| altNotifIpv6Addrs | array(Ipv6Addr) | O | 1 . . . N | Alternate or backup IPv6 | |
| | | | | Address(es) where to send | |
| | | | | Notifications. | |
| altNotifFqdns | array(Fqdn) | O | 1 . . . N | Alternate or backup FQDN(s) | |
| | | | | where to send Notifications. | |
| eventSubs | array(EventSubscription) | M | 1 . . . N | Subscribed events | |
| ImmeRep | Boolean | O | 0 . . . 1 | It is included and set to true if the | |
| | | | | immediate reporting of the current | |
| | | | | status of the subscribed event, if | |
| | | | | available is required. | |
| notifMethod | NotificationMethod | O | 0 . . . 1 | If “notifMethod” is not supplied, the | |
| | | | | default value | |
| | | | | “ON_EVENT_DETECTION” | |
| | | | | applies. | |
| maxReportNbr | Uinteger | O | 0 . . . 1 | If omitted, there is no limit. | |
| expiry | DateTime | C | 0 . . . 1 | This attribute indicates the expiry | |
| | | | | time of the subscription, after | |
| | | | | which the SMF shall not send any | |
| | | | | event notifications and the | |
| | | | | subscription becomes invalid. It | |
| | | | | may be included in an event | |
| | | | | subscription request and may be | |
| | | | | included in an event subscription | |
| | | | | response based on operator | |
| | | | | policies. If an expiry time was | |
| | | | | included in the request, then the | |
| | | | | expiry time returned in the | |
| | | | | response should be less than or | |
| | | | | equal to that value. If the expiry | |
| | | | | time is not included in the | |
| | | | | response, the NF service | |
| | | | | consumer shall not associate an | |
| | | | | expiry time for the subscription. | |
| repPeriod | DurationSec | C | 0 . . . 1 | Is supplied for notification Method | |
| | | | | “periodic”. | |
| guami | Guami | C | 0 . . . 1 | The Globally Unique AMF | |
| | | | | Identifier (GUAMI) shall be | |
| | | | | provided by an AMF as NF service | |
| | | | | consumer. | |
| serviceName | ServiceName | O | 0 . . . 1 | If the NF service consumer is an | |
| | | | | AMF, it should provide the name of | |
| | | | | a service produced by the AMF | |
| | | | | that makes use of the notification | |
| | | | | about subscribed events. | |
| supportedFeatures | SupportedFeatures | C | 0 . . . 1 | List of Supported features used as | |
| | | | | described in subclause 5.8. | |
| | | | | This parameter shall be supplied | |
| | | | | by NF service consumer and SMF | |
| | | | | in the POST request that request | |
| | | | | the creation of an SMF Notification | |
| | | | | Subscriptions resource and the | |
| | | | | related reply, respectively. | |
| sampRatio | SamplingRatio | O | 0 . . . 1 | Indicates the ratio of the random | |
| | | | | subset to target UEs, event reports | |
| | | | | only relates to the subset. | |
| partitionCriteria | array(PartitioningCriteria) | O | 1 . . . N | Defines criteria for partitioning the | EneNA |
| | | | | UEs in order to apply the sampling | |
| | | | | ratio for each partition. It may only | |
| | | | | be included in event subscription | |
| | | | | requests when the “sampRatio” | |
| | | | | attribute is also provided. (NOTE 3) | |
| grpRepTime | DurationSec | O | 0 . . . 1 | Indicates the time for which the | |
| | | | | SMF aggregates the event reports | |
| | | | | detected by the UEs in a group | |
| | | | | and report them together to the NF | |
| | | | | service consumer. | |
| notifFlag | NotificationFlag | O | 0 . . . 1 | Indicates the notification flag, | EneNA |
| | | | | which is used to mute/unmute | |
| | | | | notifications and to retrieve events | |
| | | | | stored during a period of muted | |
| | | | | notifications. | |
| | | | | Default: “ACTIVATE” | |

(NOTE 1):
If the event subscription applies for a specific PDU session, the PDU session of a single UE (pduSeId, and gpsi/supi) shall be included; otherwise one and only one of a single UE (gpsi/supi), a group of UEs (groupId), or anyUeInd set to true shall be included.
(NOTE 2):
If the UDM as NF service consumer subscribes to event (e.g. downlink data delivery status, PDU Session Establishment, PDU Session Release) on behalf of AF/NEF, “notifId” shall be set the same as “referenceId” received from the AF/NEF as defined in subclause 6.4.6.2.4 of 3GPP TS 29.503 .
(NOTE 3):
For a given type of partitioning criteria, the UE shall belong to only one single partition as long as it is served by the NF service producer.
(NOTE x):
If a group of UEs(groupId) or anyUeInd set to true is included, any of “dnn” and “snssai” attributes may be included.

*** End of Changes ***

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, may be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that may direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

### ABBREVIATIONS

3GPP 3rd Generation Partnership Project
4G the 4th Generation Mobile Communication Technology
5G the 5th Generation Mobile Communication Technology
AF Application Function
API Application Programming Interface
AS Application Server
DNN Data Network Name
EPC Evolved Packet Core
EPS Evolved Packet System
GPSI Generic Public Subscription Identifier
MSISDN Mobile Subscriber Integrated Services Digital Network Number
NEF Network Exposure Function
NF Network Function
NRF Network Repository Function
PDN Packet Data Network
PDU Packet Data Unit
SCS Service Capability Server
SMF Session Management Function
S-NSSAI Single Network Slice Selection Assistance Information
SUPI Subscription Permanent Identifier
UDM Unified Data Management
UDR Unified Data Repository
UE User Equipment.

1. A method performed by a first network function implementing application function, comprising:
transmitting, to a second network function implementing network exposure function, a first subscription message comprising at least one of Data Network Name (DNN) of a data network and Single Network Slice Selection Assistance Information (S-NSSAI), for monitoring an event status for a User Equipment (UE) or a group of UEs; and
receiving, from the second network function, a first notification message comprising information indicating the event status.

2. The method according to claim 1, wherein the first subscription message further comprises at least one of an external group ID indicating the group of UE, an external UE ID indicating a specific UE, a Mobile Subscriber Integrated Services Digital Network Number (MSISDN) indicating a specific UE, a Generic Public Subscription Identifier (GPSI) indicating a specific UE, and an indication indicating any UE.

3. The method according to claim 1, wherein the event status is a Packet Data Network (PDN) connectivity status or a downlink data delivery status.

4. A method performed by a second network function implementing network exposure function, comprising:
receiving, from a first network function implementing application function, a first subscription message comprising at least one of Data Network Name (DNN) of a data network and Single Network Slice Selection Assistance Information (S-NSSAI), for monitoring an event status for a User Equipment (UE) or a group of UEs;
determining a third network function implementing session management function or a fourth network function implementing unified data management function; and
transmitting, to the determined network function, a second subscription message comprising at least one of the DNN and S-NSSAI.

5. The method according to claim 4, wherein the first subscription message further comprises at least one of an external group ID indicating the group of UE, an external UE ID indicating a specific UE, a Mobile Subscriber Integrated Services Digital Network Number (MSISDN) indicating a specific UE, a Generic Public Subscription Identifier (GPSI) indicating a specific UE, and an indication indicating any UE.

6. The method according to claim 5, wherein determining the network function further comprising:
querying a fifth network function implementing network repository function for a fourth network function implementing unified data management based on at least one of the external group ID, the external UE ID, the MSISDN, and the GPSI.

7. The method according to claim 5, further comprising:
performing, based on a local policy, an authorization for at least one of the external group Id, the DNN, the external UE ID, the MSISDN, the GPSI, and the S-NSSAI.

8. The method according to claim 5, wherein determining the network function further comprising:
querying a fifth network function implementing network repository function for one or more third network functions implementing session management functions based on the DNN and the S-NSSAI.

9. The method according to claim 8, further comprising one of:
translating the external group ID to an internal group ID based on a local policy; or
translating the MSISDN or the external UE ID to GPSI based on a local policy.

10. The method according to claim 8, further comprising:
querying the fifth network function implementing network repository function for a fourth network function implementing unified data management based on the external group ID;
transmitting, to the fourth network function implementing unified data management, a request comprising external group ID; and
receiving, from the fourth network function implementing unified data management, the internal group ID.

11. The method according to claim 4, further comprising:
receiving, from the third network function implementing session management function, a second notification message comprising information indicating the event status; and
transmitting, to the first network function, a first notification message comprising information indicating the event status.

12. The method according to claim 4, wherein the event status is a Packet Data Network (PDN) connectivity status or a downlink data delivery status.

13. A first network function implementing application function, comprising:
at least one processor; and
a non-transitory computer readable medium coupled to the at least one processor, the non-transitory computer readable medium contains instructions executable by the at least one processor, whereby the at least one processor is configured to perform the following steps:
transmitting, to a second network function implementing network exposure function, a first subscription message comprising at least one of Data Network Name (DNN) of a data network and Single Network Slice Selection Assistance Information (S-NSSAI), for monitoring an event status for a User Equipment (UE) or a group of UEs; and
receiving, from the second network function, a first notification message comprising information indicating the event status.

14-16. (canceled)

17. The first network function according to claim 13, wherein the first subscription message further comprises at least one of an external group ID indicating the group of UE, an external UE ID indicating a specific UE, a Mobile Subscriber Integrated Services Digital Network Number (MSISDN) indicating a specific UE, a Generic Public Subscription Identifier (GPSI) indicating a specific UE, and an indication indicating any UE.

18. The first network function according to claim 13, wherein the event status is a Packet Data Network (PDN) connectivity status or a downlink data delivery status.

19. The method according to claim 7, wherein determining the network function further comprising:
querying a fifth network function implementing network repository function for one or more third network functions implementing session management functions based on the DNN and the S-NSSAI.

20. The method according to claim 19, further comprising one of:
translating the external group ID to an internal group ID based on a local policy; or
translating the MSISDN or the external UE ID to GPSI based on a local policy.

21. The method according to claim 19, further comprising:
querying the fifth network function implementing network repository function for a fourth network function implementing unified data management based on the external group ID;
transmitting, to the fourth network function implementing unified data management, a request comprising external group ID; and
receiving, from the fourth network function implementing unified data management, the internal group ID.
